(19) United States
(12) Patent Application Publication
(10) Pub. No.: US 2005/0044095 A1
(43) Pub. Date: Feb. 24, 2005

(54) Collection symbolic job expander

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/645,487

(22) Filed: Aug. 22, 2003

(51) Int. Cl. G06F 17/00; G06F 7/00

(52) U.S. Cl. 707/101

(57) ABSTRACT

A Collection Symbolic Job Expander enables people and programs to use convenient, symbolic job request expressions to perform complex operations on large numbers of collections with essentially no human effort involved. Collections are data-typed sets of computer files that can be manipulated as a set, rather than as individual files. In operation, a Collection Symbolic Job Expander receives a collection symbolic job request from a request originator, and performs a collection job expansion action on the request to produce a list of expanded job requests. Each expanded job request is comprised of a collection name, a user-defined computing platform name, and a processing dependency order ranking. Collection Symbolic Job Expanders improve human productivity by enabling people to perform operations on large sets of collections without being required to provide low-level processing details such as specific collection names, specific computing platform assignments, or processing dependency information. Collection Symbolic Job Expanders thereby enable the construction of advanced automated collection processing systems that can process large sets of collections in distributed, multiplatform, scalable ways that were not previously known to the art.

### RELATED APPLICATIONS

The present inventive application builds on several inventive principles that are disclosed in previous applications, by using those inventive principles as a foundation for the inventive method and data structures disclosed in the present application.

This application is related to USPTO patent application Ser. No. 09/885078, filed Jun. 21, 2001, by Kevin W Jameson, titled “Collection Information Manager,” which discloses an inventive method and structure for delivering collection information to application programs. “Collections”—a special lexicographic term—are inventive data structures that enable the inventive methods and structures in this series of inventions.

This application is related to USPTO patent application Ser. No. 09/885079, filed Jun. 21, 2001 by Kevin W Jameson, titled “Collection Knowledge System,” which discloses an inventive method and structure for delivering context-sensitive knowledge to application programs, and which is incorporated herein by reference.

This application is related to USPTO patent application Ser. No. 10/227,848, filed Aug. 27, 2002 by Kevin W Jameson, titled “Collection Storage System,” which discloses an inventive method and structure for managing the storage and evolution of collections by performing collection storage operations on collections and collection views, and which is incorporated herein by reference.

This application is related to USPTO patent application Ser. No. 10/227,822, filed Aug. 27, 2002 by Kevin W Jameson, titled “Collection Shortcut Expander,” which discloses an inventive method and structure for delivering expanded collection references to programs, and which is incorporated herein by reference.

This application is related to USPTO Patent Application Number Unassigned, filed contemporaneously herewith by Kevin W Jameson, titled “Collection Processing System,” which discloses an inventive method and structure for processing collections in a fully automated, distributed, multiplatform, and scalable way, and which is filed contemporaneously herewith.

### FIELD OF THE INVENTION

This invention relates to computer software programs for processing collections in arbitrary ways, thereby increasing the productivity of software developers and other knowledge workers that routinely work with computer files. Collections are inventive data structures that allow trees of computer files to be manipulated as a data-typed set, rather than as individual files.

### BACKGROUND OF THE INVENTION

Terminology

This application uses special terminology and associated lexicographic meanings to clearly define the inventive concepts and structures of the present invention.

Readers should be careful not to confuse the intended meanings of special terms such as “collection” in this application with the common dictionary meanings of these words. In particular, much novel and inventive structure is introduced into the claims by including these special terms in claim clauses that narrow and limit the claims.

The term “collection” herein normally refers to a tree of computer files that can be manipulated as an integrated, recognizable, data-typed set, rather than as individual computer files. Collections—unlike normal file system folders—have a defined structure, contain a collection specifier file, and contain a collection data type indicator that links to a collection type definition. Collections are manipulated according to data handling policies that are defined in a collection type definition, and may contain optional collection content that is recognized and manipulated according to policies defined in a collection type definition. Formally, the term “collection” refers to an inventive data structure that is the union of collection specifier information and collection content information.

The term “collection specifier” refers to an inventive data structure that contains information about a collection instance. For example, collection specifiers may define such things as a collection type, a text summary description of the collection, collection content members, derivable output products, collection processing information such as processing parallelism limits, special collection processing steps, and program option overrides for programs that manipulate collections. Collection specifiers are typically implemented as simple key-value pairs in text files or database tables.

The term “collection type definition” refers to an inventive data structure that contains user-defined sets of attributes that can be shared among multiple collections. Collection type definitions typically define such things as collection types, product types, file types, action types, administrative policy preferences, and other information that is useful to application programs for understanding and processing collections of a particular collection type.

The term “collection information” refers to an inventive data structure that is the union of collection specifier information, collection type definition information, and collection content information. Collection information is what application programs need to know in order to “understand” and process collections in a smart way, in accordance with local site policies.

### BACKGROUND

The present invention addresses the general problem of low productivity among human knowledge workers who use tedious manual procedures to work with groups of computer files. The most promising strategy for solving this productivity problem is to build automated computer systems to replace manual human effort.

One new software technology for improving productivity—software collections—enables people and computer programs to process collections of computer files more productively than previously possible. Collections are normal directory structures (“file folders”) of normal computer files, but they contain a special collection specifier file in the root directory of the collection. Collection specifier files are designed to be parsed by computers, and specify, among many other things, data types for collections. Computer programs can use collection data type values as lookup keys into databases containing collection type definitions, to obtain detailed information about known collection data types. Detailed information from collection type definitions enables computer programs to better understand the structure and content of collections that are being processed. Having access to detailed information about collections enables computer programs to process collections in more intelligent ways than were previously possible

Collections are useful and practical because they make it easier for computer programs to manipulate the contents of collections in useful ways. In one typical scenario, users invoke computer programs within a working directory contained within a collection directory tree structure. Computer programs recognize the location of a current collection by searching upwards for a special collection specifier file. Once programs know the physical location—the root directory—of a current collection, they can obtain corresponding collection information for the collection, and then manipulate it in intelligent ways to fulfill their processing functions.

Although collections are useful and practical for representing collections of computer files, no scalable computer systems exist for processing either individual collections or sets of collections in convenient ways. This is a significant practical limitation, because scalable collection processing systems could significantly increase the productivity of people who routinely work with collections. In particular, a scalable, multiplatform collection processing system would greatly improve the productivity of software developers who perform distributed multiplatform software builds that involve large numbers of software files.

Need for a Collection Processing System

An ideal collection processing system would accept simple, convenient, and high-level collection processing commands (collection symbolic job requests) from people, and would perform the requested job operations automatically, without requiring any further detailed processing information from the people who submitted the job request

People could thereby perform complex processing tasks on large numbers of collections without having to remember or specify tedious processing details such as long lists of specific collection names, or which computing platforms should be used to process each collection in a set, or long lists of processing dependency relationships that might exist among individual collections within a set of collections that is being processed.

Need for a Simple, Symbolic Collection Job Syntax

For example, it is desirable to enable people to simply tell a collection processing system what to do using a simple syntax such as “system, perform this symbolic task on this symbolic collection reference”, rather than having to provide the system with long lists of tedious processing details. This kind of job syntax would enable people to think and work at a very high level (“system, do this to that”), without being concerned with the low-level processing details of how a system actually performed the requested work.

In order to implement such a scalable collection processing system, two important technical means are required. First, a means is required for using simple symbolic collection references to refer to large sets of collections. Second is a means for supplying a collection processing system with low-level processing details required to carry out a requested computation, such as lists of computing platforms to be used for processing each collection, and dependency orderings among collections.

The first means requirement is satisfied by collection reference expressions. Collection reference expressions are convenient, human-oriented expressions that refer to groups of collections that are accessible through a collection storage system. Collection reference expressions and collection storage systems are described in the prior art.

See the list of related patent applications at the beginning of this document for more information on collection storage systems and collection shortcut expressions.

The second means requirement is satisfied by the present Collection Symbolic Job Expander invention, which contemplates an inventive method and structure for expanding non-executable, high-level, collection symbolic job requests into an expanded collection job list. An expanded collection job list contains more low-level, detailed job requests that contain actual collection names, computing platforms, and processing dependency orderings. Jobs on the expanded collection job list can actually be carried out by a collection processing system, whereas symbolic job requests cannot be executed directly.

The term “collection job expansion action” refers to the inventive method by which a symbolic collection job request is expanded into an expanded collection job request list. (A single symbolic job request can be expanded into many expanded jobs on an expanded collection job request list.) The present Collection Symbolic Job Expander invention provides an inventive method and data structures for performing collection job expansion actions.

Syntax of Symbolic and Expanded Job Lists

An ideal job syntax would enable people to say “system, do this (task) to that (collection reference).” Collection symbolic job requests fulfill this ideal syntax, thereby enabling people to tell a collection processing system what needs to be done at a very high level, without being concerned with providing low level processing details.

The present Collection Symbolic Job Expander invention expands symbolic job requests into an expanded job list that can actually be executed by a collection processing system. Jobs on the expanded job list contain enough specific information to be carried out by a collection processing system.

A collection symbolic job request is comprised of two parts: (1) a symbolic task operation (“system, do this”) and (2) an optional symbolic collection reference expression (“to that”). The collection reference expression is optional, because it is not always required to perform practical work. For example, people might only want to say “system, do this” (where no collection reference argument is required).

An expanded job request is comprised of a list of “triplet” jobs. Triplet jobs are given the “triplet” name because each expanded job on the list contains the original symbolic task name, plus a triplet of lower-level job information. A triplet is comprised of an actual collection name, an actual computing platform to use, and a job processing ranking value (a visit order value) to ensure that expanded jobs are executed (visited) in proper dependency order. Before execution, the list of expanded job triplets is sorted by visit order value, to enforce a proper dependency processing ordering on all jobs in the list.

Practical Applications in the Technical Arts

The present Collection Job Expander invention contemplates an inventive method and inventive data structures for expanding a symbolic job request (“do this to that”) into a list of triplet jobs (“do this to collection-name on platform-name using priority visit-order-value”). It thereby frees people from the responsibility of having to remember long lists of actual collection names, corresponding computing platform names, and visit ordering relationships, and provides people with a corresponding increase in productivity.

One notable practical application in the technical arts of the present Collection Symbolic Job Expander is in the field of distributed multiplatform software builds. The present invention expands simple symbolic job requests into expanded job triplet lists that represent specific computing work that must be done to carry out complex, distributed, multiplatform software builds, with no additional human labor required.

A second practical application in the technical arts of the present Collection Symbolic Job Expander is in the field of automated collection processing systems, which can use job expanders to translate high-level symbolic job requests into lists of expanded job requests. Collection Symbolic Job Expanders can be implemented as part of collection processing systems, as part of application programs, or as standalone job expanders. Collection processing systems are not limited to performing only distributed multiplatform software builds-instead, arbitrary computations on collections are possible.

Many other practical applications of the present invention are also possible. Those skilled in the programming art can see that the present Collection Symbolic Job Expander invention is practical and useful in a large number of computer applications, wherever it is convenient for people to use simple collection symbolic job requests to perform complex operations on large sets of collections.

Subproblems to Solve

The overall collection job expansion problem has several important parts, so it is useful to divide the overall problem into smaller subproblems that are easier to understand. The following paragraphs characterize several of those subproblems.

The Collection Symbolic Job Expansion Problem is the overall problem to solve. It is the problem of how to expand a high-level, symbolic job request into a list of low-level, detailed job requests that can be executed by a collection processing system. Solving this problem will free people from having to provide detailed processing information to computer programs that process large numbers of collections. Instead, people can use simple collection symbolic job requests, and let automated collection job expanders determine other detailed processing information.

The Collection Symbolic Job Expansion Problem has at least the following interesting aspects: collection reference expressions are optional; multiple collection references may be involved in one expansion operation; collection references may be normal collection references or collection shortcut references; collections may be stored in multiple collection storage systems; other information beyond computing platform and visit ordering may be associated with each expanded job request; and different job expanders can be used to produce different expansions of the same symbolic job request.

The Collection Reference Expansion Problem is another problem to solve. It is the problem of how to calculate a list of individual collections to process from a single symbolic collection reference expression. Solving this problem will enable people to conveniently reference and process large sets of collections as easily as they can process individual collections.

For example, people will not need to have any practical knowledge of the specific breakdown of a symbolic collection reference expression. Instead, they will only need to have an understanding of what the reference expression means, such as “all collections that comprise software product 1”, rather than knowing exactly which individual collections are implied by the reference.

The Collection Job Expansion Problem has at least the following interesting aspects: a collection reference expression can indirectly reference arbitrary numbers of collections, including collection groups. In addition, job expansion calculations require the use of collection information, which may be obtained from a collection storage system or equivalent information repository.

The Collection Platform Assignment Problem is another problem to solve. It is the problem of how to calculate a list of computing platforms on which to process a particular collection in a multiplatform computing environment. Since each collection in a set of collections may require processing on a different set of computing platforms, solving this problem will enable people to request large collection job processing jobs without being responsible for providing low-level platform assignment details.

The Collection Platform Assignment Problem has at least the following interesting aspects: a platform assignment list can contain multiple platforms for one collection; a collection can be processed on individual or multiple computing platforms, sequentially or simultaneously; lists of appropriate computing platforms for collections are context-sensitive; lists of appropriate computing platforms are dependent on collection type and collection build type; and users can specify particular, user-defined platform assignments as part of collection job requests.

The Collection Visit Ordering Problem is another problem to solve. It is the problem of how to calculate and properly schedule processing dependencies among multiple collections, so that collections are processed (visited) in proper dependency order. Solving this problem will enable people to perform complex processing tasks on large sets of collections without being responsible for understanding and controlling processing dependencies among individual collections within a set of collections.

The Collection Visit Ordering Problem has at least the following interesting aspects: arbitrary numbers of collections may be involved; arbitrary user-defined collection types may be involved; processing dependencies may vary with collection type; and collection information may not be available to the originator of the collection processing request.

General Shortcomings of the Prior Art

A search of the prior art found no disclosures that cited information close enough to the present invention to be worth referencing. A USPTO patent examiner specifically requested that irrelevant material NOT be included for the sole purpose of citing some prior art in the present application. Since I could find no RELEVANT prior art that related to collections, symbolic job requests, or job expansions, no such prior art is listed herein.

The prior art contains no references that are relevant to the present invention. In particular, the prior art does not discuss collections, nor does it discuss symbolic job requests for collection processing systems. Accordingly, the following discussion is general in nature, because there are no relevant specific works of prior art to discuss.

Prior art approaches, including prior art software build systems, lack support for collections and collection processing systems. This is the largest limitation of all because it prevents people and programs from using high-level collections to significantly improve productivity.

Prior art approaches lack support for expanding symbolic collection references into lists of actual collection names. This limitation prevents people from performing processing tasks on sets of collections as easily as they can work with individual collections. Instead, people must process large groups of collections by tediously processing each collection in a group individually, one at a time.

Prior art approaches lack support for automatically determining which computing platforms should be used to process collections in multiplatform computing environments. This limitation prevents people from conveniently processing large sets of collections in multiplatform computing environments without having to provide low-level processing details such as desired processing platform assignments for each collection in a set.

Prior art approaches lack support for automatically determining a processing dependency ordering for each collection in a set of collections. This limitation prevents people from easily processing large sets of collections without having to provide low-level processing details such as a desired collection processing order for each collection in a set.

As can be seen from the above descriptions, prior art approaches lack the means to make it easy—or even possible—for people to conveniently perform complex processing tasks on large sets of collections without providing many low-level processing details. Prior art approaches lack practical means for modelling collections, collection processing systems, symbolic collection job requests, collection reference expansions, collection processing platform assignments, and collection processing dependencies.

In contrast, the present invention has none of these limitations, as the following disclosure will show.

### SUMMARY OF THE INVENTION

A Collection Symbolic Job Expander improves the productivity of people who work with collections by enabling them to use convenient symbolic collection job requests to perform operations on large sets of collections. Symbolic job requests are comprised of a symbolic task name and a collection reference expression.

A Collection Symbolic Job Expander expands a symbolic job request into a list of expanded job requests that are each comprised of the original symbolic task name, a collection name, a computing platform name, and a visit order value.

A Collection Symbolic Job Expander is comprised of one or more software modules that implement the functions of expanding symbolic collection references, determining platform assignment information, and determining collection visit order information.

In operation, a Collection Symbolic Job Expander receives a collection symbolic job request from a request originator. A request originator can be an application program, or a person. A Collection Symbolic Job Expander proceeds by expanding a symbolic collection reference into a list of actual collection names. Then it determines platform assignments and collection visit order values for each actual collection name in the list. A single list of triplet job requests is formed from lists of actual collection names, lists of platform assignments, and lists of visit order values. Each job triplet contains a collection name, a computing platform name, and a visit order value. The list of triplets is sorted by collection visit order values to enforce proper processing dependency orderings. Finally, each triplet may be combined with the original symbolic task name. The list of expanded job requests is then returned to the request originator.

Collection Symbolic Job Expanders are useful and practical because they enable people to conveniently perform complex processing tasks on large sets of collections without having to manage tedious job processing details such as providing specific collection names, computing platform assignments, visit ordering dependencies, or other job processing details. By dynamically and automatically expanding collection symbolic job requests, inventive collection symbolic job expanders enable people to perform collection processing tasks that were not previously possible using prior art techniques.

### OBJECTS AND ADVANTAGES

The main object of the present Collection Symbolic Job Expander invention is to improve the productivity of people who work with computer files by enabling them to perform complex processing tasks on large sets of collections using simple collection symbolic job requests. A Collection Symbolic Job Expander expands high-level symbolic job requests into lists of low-level job requests that contain detailed processing information required to carry out the requested computations.

Another object is to enable people to use a convenient, high-level syntax for requesting collection processing jobs. Enabling people to use a syntax of the form “system, do this (symbolic task name) to that (collection reference)” will greatly increase the scope, power, and convenience of their job requests, while freeing people from being responsible for managing low-level job processing details such as lists of collection names, computing platforms, and dependency visit ordering values.

Another object is to solve the Collection Reference Expansion Problem by providing inventive means for dynamically expanding a symbolic collection reference expression into a list of actual collection names in a scalable, automated way.

Another object is to solve the Collection Platform Assignment Problem by providing inventive means for dynamically calculating a list of computing platforms on which to process particular collections.

Another object is to solve the Collection Visit Ordering Problem by providing inventive means for dynamically calculating and properly scheduling processing dependencies among multiple collections and multiple computing platforms.

As can be seen from the objects that are listed above, Collection Job Expanders provide many useful and practical services to people who work with collections.

Further advantages of the present Collection Job Expander invention will become apparent from the drawings and disclosures that follow.

### BRIEF DESCRIPTION OF DRAWINGS

The following paragraphs introduce the drawings.

FIG. 1 shows a sample prior art file system folder from a typical personal computer.

FIG. 2 shows how a portion of the prior art folder in FIG. 1 has been converted into a collection 100 by the addition of a collection specifier file 102 named “collspec” FIG. 2 Line 5. Collection specifier files are inventive data structures that form part of collections.

FIG. 3 shows the contents of a collection specifier file 102, implemented with a simple text file from a typical personal computer system.

FIG. 4 shows a filesystem tree containing several collections, located at various hierarchical levels (depths) within the tree.

FIG. 5 shows a list of pathnames that show the filesystem locations of the collections in the tree of FIG. 4.

FIG. 6 shows a prior art CM system that does not understand collections.

FIG. 7 shows a Collection Storage System (CSS) that does understand collections, and that is capable of performing collection-aware operations.

FIG. 8 shows the structure of a complete collection reference.

FIG. 9 shows an example collection reference that is a normal “whole collection” reference for the collection shown in FIG. 2.

FIG. 10 shows a table of shortcut collection references and their meanings.

FIG. 11 shows the structure of a collection symbolic job request.

FIG. 12 shows two example collection symbolic job requests.

FIG. 13 shows the results of a collection reference name expansion.

FIG. 14 shows the results of a visit order expansion.

FIG. 15 shows a list of four user-defined computing platform names.

FIG. 16 shows a list of one computer platform, this time for a different collection.

FIG. 17 shows the results of a collection reference, a visit order, and a platform expansion for a single collection.

FIG. 18 shows the results of a collection reference, a visit order, and a platform expansion for another single collection.

FIG. 19 shows the results of a collection reference, a visit order, and a platform expansion for the original symbolic job request of FIG. 12.

FIG. 20 shows an inventive data structure for holding collection symbolic job expansion information.

FIG. 21 shows a simplified architecture for an application program means 120 that uses a module Collection Symbolic Job Expander Means 150 to expand symbolic job requests into expanded job triplet lists.

FIG. 22 shows a simplified algorithm for an Application Program Means 120 that uses a module Collection Symbolic Job Expander Means 150 to expand incoming symbolic job requests.

FIG. 23 shows a simplified architecture for a collection processing system that uses a module Collection Symbolic Job Expander Means 150.

FIG. 24 shows a simplified algorithm for the collection processing system of FIG. 23.

FIG. 25 shows a simplified architecture of a Collection Symbolic Job Expander Means 150.

FIG. 26 shows a simplified algorithm for a module Collection Symbolic Job Expander Means 150.

FIG. 27 shows a simplified architecture for a module Expand Collection Reference Means 151.

FIG. 28 shows a simplified algorithm for a module Expand Collection Reference Means 150.

FIG. 29 shows a simplified architecture for a module Expand Visit Order Means 152.

FIG. 30 shows a simplified algorithm for a module Expand Visit Order Means 152.

FIG. 31 shows a collection type name table that would typically be stored in a Collection Knowledge System 125.

FIG. 32 shows an example collection type definition file for a collection type “ct-program-c.”

FIG. 33 shows an example collection type definition file for a collection type “ct-library-c.”

FIG. 34 shows a default visit order table such as would be stored in a Collection Knowledge System 125.

FIG. 35 shows an example collection specifier file “collspec” for the collection named “c-library-two” shown in FIG. 4 Line 10.

FIG. 36 shows visit order values for the collections shown in the tree of FIG. 4.

FIG. 37 shows an unsorted list of individual collection names and visit order rankings.

FIG. 38 shows a list of individual collection names, sorted by visit order rankings.

FIG. 39 shows a simplified architecture for a module Expand Processing Platform Means 153.

FIG. 40 shows a simplified algorithm for a module Expand Processing Platform Means 153.

FIG. 41 shows a processing platform name table from a collection knowledge system.

FIG. 42 shows an example processing platform type definition file for a processing platform type of “pp-program-c.”

FIG. 43 shows an example processing platform type definition file for a processing platform type of “pp-web-page.”

FIG. 44 shows a simplified architecture for a Collection Symbolic Job Expander Means 150 that uses three modules 171-173 that manage particular types of information that are required to perform symbolic job expansion actions.

### LIST OF DRAWING REFERENCE NUMBERS

100 A collection formed from a prior art file folder
102 A collection specifier file
105 Local copies of authoritative files
106 Authoritative files in a CM repository
107 Local copies of authoritative collections
108 Authoritative collections in a CSS repository
110 A Configuration Management System Client
111 A Configuration Management System Server
112 A Do Non-Collection Operations Means
115 A Collection Storage System Client Means
116 A Collection Storage System Server Means
117 A Collection Storage Operation Manager Means
120 An Application Program Means
121 A Get Symbolic Job Request Means
123 A Use Expanded Job List Means
124 A Collection Storage System (CSS)
125 A Collection Knowledge System (CKS)
140 A Collection Processing System (CPS) Client Means
141 A CPS Queue Manager Means
142 A CPS Job Dispatcher Means
143 A CPS Execution Server #1 Means
144 A CPS Execution Server #2 Means
145 A CPS Execution Server #3 Means
146 A CPS Job Reporter Means
150 A Collection Symbolic Job Expander (CSJE) Means
151 An Expand Collection Reference Means
152 An Expand Visit Order Means
153 An Expand Processing Platform Means
154 A Build CSJE Data Structure Means
161 An Append Collection Names Means
162 An Append Visit Order Means
163 An Append Processing Platform Means
171 A Collection Namespace Manager Means
172 A Collection Instance Information Manager Means
173 A Collection Processing Platform Manager Means

### DETAILED DESCRIPTION

The following disclosure describes the present Collection Symbolic Job Expander invention with reference to a preferred file system implementation of collections, such as found on a personal computer. However, the invention is not limited to any particular computer architecture, operating system, file system, database, or other software implementation. The descriptions that follow should be considered as implementation examples only and not as limitations of the invention.

Introduction To Collections

This patent application uses special terminology and associated lexicographic meanings to clearly define the inventive concepts and structures of the present invention. Many of the special terms below refer to inventive data structures that play a major role in this and other collection-oriented inventions described in related patent applications.

Readers should be careful not to confuse the intended meanings of special terms such as “collection” in this application with the common dictionary meanings of these words. In particular, much novel and inventive structure is introduced into the claims by including these special terms in claim clauses that narrow and limit said claims.

Collections are inventive data structures that enable both people and programs to manipulate sets of computer files in “smart” ways, according to the data type of the collection and the processing policies defined for particular collection data types.

Collection information is comprised of three major parts: (1) a collection specifier that contains information—such as a collection data type—about a collection instance, (2) a collection type definition in a knowledge base that contains information about how to process all collections of a particular type, and (3) optional collection content in the form of arbitrary computer files that belong to a collection.

Collection specifiers contain information about a collection instance. For example, collection specifiers may define such things as the collection data type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables. Collection specifiers are inventive data structures that contain strongly structured, machine readable and writeable information, and are very different than common text files such as “readme.txt” files.

Collection type definitions are user-defined sets of attributes that are stored in a central knowledge base so they can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within a collection subtree are collection content members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collections have many practical applications in the technical arts. They make it convenient for programs and human knowledge workers to manipulate whole data-typed sets of computer files where only individual files could be manipulated before. They make it possible to manipulate collections according to standard processing policies that are defined in a collection type definition in a shared database.

Collection Representations

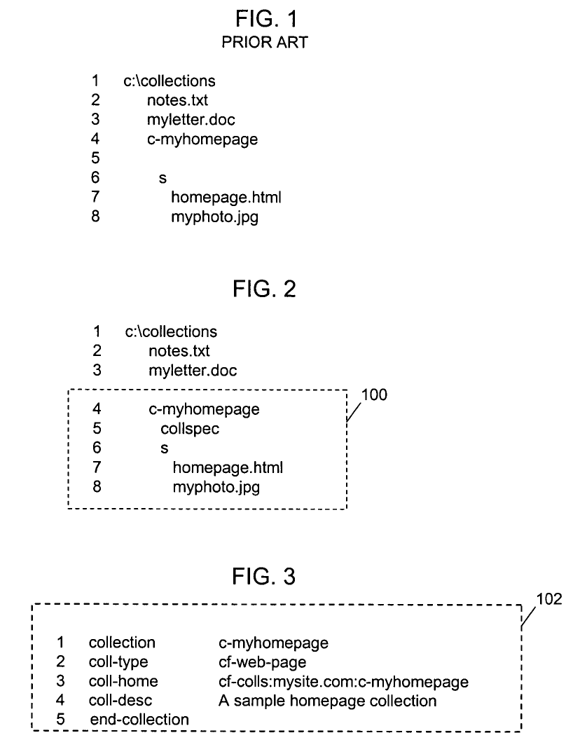

FIGS. 1-3 show a preferred embodiment of collections for a typical personal computer.

FIG. 1 shows a sample prior art file system folder from a typical personal computer. Since this file folder does not contain a collection specifier file, it does not meet the definition of a collection, and therefore is not a collection.

FIG. 2 shows the prior art folder of FIG. 1, but with a portion of the folder converted into a collection 100 by the addition of a collection specifier file FIG. 2 Line 5 named “collspec” (short for collection specifier). In this example, the collection contents FIG. 2 Lines 4-8 of collection 100 are defined by two implicit policies of a preferred implementation of collections.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “collspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto.jpg” FIG. 2 Line 8 are part of the collection content for collection 100.

FIG. 3 shows an example collection specifier file 102, FIG. 2 Line 5, for use on a typical personal computer file system. Note that the collection specifier FIG. 3 Line 2 specifies the collection type of the collection to be “cf-web-page.” Collection types act as links between collection instances (located in properly structured file folders that contain a collection specifier file) and collection type definitions in a shared database. Programs extract a collection type such as “cf-web-page” from a collection specifier file, and use the extracted collection type as a lookup key into a table of collection types that in turn links to a full collection type definition.

Working with Multiple Collections

People and programs that work with collections frequently need to work with multiple collections at once. One practical example of this need is for software builds that involve multiple collections and computer files. Other practical examples are also possible, such as working with several collections of related documents, photos, data files, or web pages.

In many cases, there are processing dependencies among collections within a set of collections, requiring that some collections be processed before other collections. This is not a simple problem for automated programs to solve using prior art techniques, because there is no general way for programs to determine a correct processing order among an arbitrary set of files that reside in common filesystem folders. However, in contrast to prior art techniques, collections make it possible for automated programs to calculate a correct collection processing order.

It is important to understand that processing dependencies are not always caused by lexical file inclusion dependencies such as are commonly associated with “include” statements in programming languages. Instead, there may be link library dependencies, or dependencies concerning process-generated files, or even whimsical human preference dependencies. The prior art does not disclose structures for representing these concepts, or methods for automated programs to determine a proper processing order. In contrast, collections provide both inventive data structures and methods for representing and automatically determining a proper processing order, as the following disclosure will show.

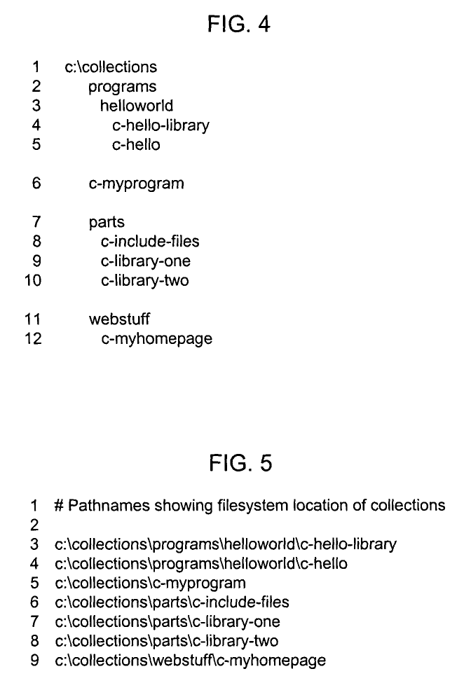

FIG. 4 shows a filesystem tree containing several collections, located at various hierarchical levels (depths) within a filesystem tree. This is a practical example of a tree that might be processed on a personal computer. It contains several collections of different collection types, including C program collections that use both C library collections and a C include file collection, and a web page collection.

FIG. 5 shows a list of pathnames that show the filesystem locations of the collections in the tree of FIG. 4. This list of pathnames, if a program could calculate the list automatically, would enable an automated program to work with the set of collections as stored on a local filesystem. (Collection recognizers solve this problem. See the list of related patent applications at the front of this document for more information.)

Determining the location of multiple collections on a local filesystem is not the subject of the present Collection Symbolic Job Expander invention. Instead, the problem addressed by the present invention is the problem of expanding collection symbolic job requests into lists of specific job requests that contain particular collection names, platform names, and visit orderings (dependency processing orderings).

For example, suppose that a person wanted to perform a predefined operation on all collections in the tree of FIG. 4. Suppose also that the person did not know where (or how) the collections in FIG. 4 were stored, and did not know what specific collections were in the tree. Suppose that all the person really knows is that they want to “do this (task) to that (set of collections in that tree).” Providing inventive structures and methods to help overcome this example problem is the subject of the present Collection Symbolic Job Expander invention.

Introduction to Collection Storage Systems

It is common practice in the software programming industry to store successive versions of computer files in a configuration management (CM) system. CM systems have a strong stabilizing effect on software development projects because they help to coordinate, control, and manage the constant stream of changes that are made to software files during a software project. For example, many modem software applications are comprised of thousands of individual computer files that are organized into related groups of files that are stored in many file folders. Mature software applications are often comprised of millions of lines of programming code.

Unfortunately, prior art CM systems can only represent and understand stored files at the file, directory, and tree levels. They have no more detailed, or more powerful way of understanding the files that they store. They can only understand simple operating system files and folders, or trees comprised of files and folders. In particular, prior art CM systems—with the exception of Collection Storage Systems—do not understand collections. See the list of related patent applications at the beginning of this document for more information on collection storage systems.

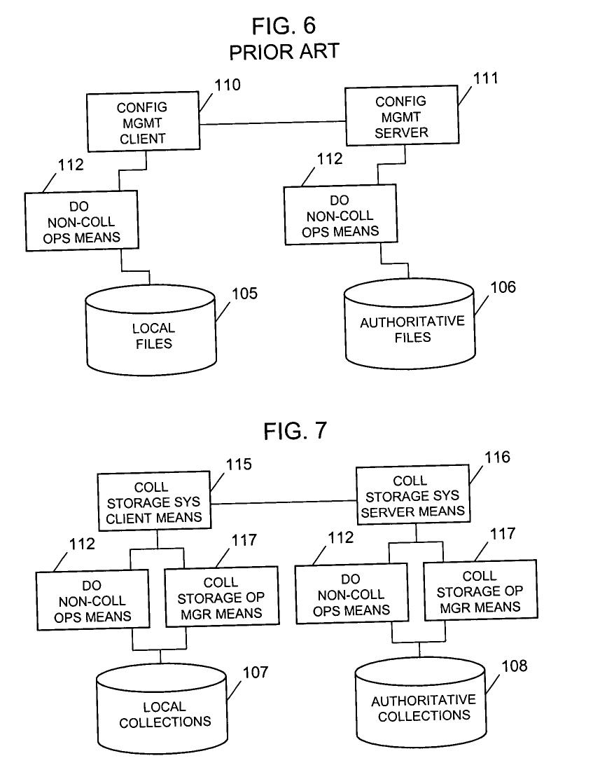

FIG. 6 shows a prior art CM system that does not understand collections. This system is incapable of performing collection-aware operations on collections. This system is comprised of a CM client module 110 and a CM server module 111. Both client and server modules can perform non-collection aware operations using a software operations module 112 that does not understand collection operations. The CM client 110 can transfer files from the authoritative CM server storage database 106 to its local filesystem 105, and back again. Typically, the CM client 110 will reference groups of files by explicit file name, by file folder name (a directory name), or by a user-defined symbolic group or module name that is a shortcut name for a single directory name.

Prior art CM systems enable people to reference groups of files by symbolic group name or file folder name, without requiring people to know precisely which files are included in the specified folder or group name. This is a convenient capability, because it relieves people of having to remember and manage detailed lists of files.

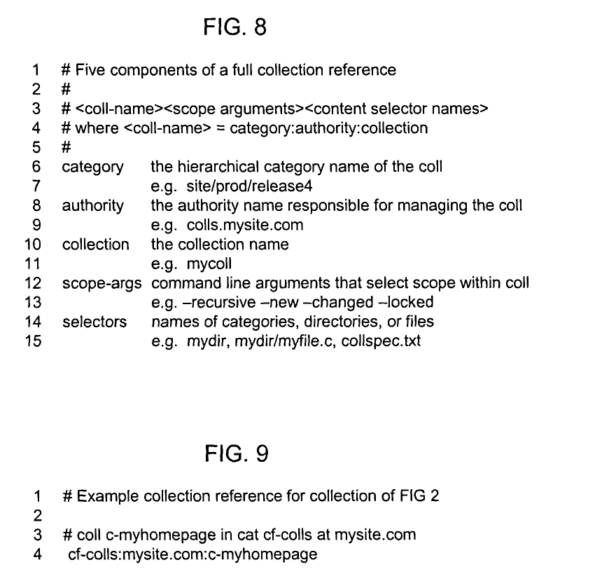

FIG. 7 shows a Collection Storage System (CSS) that does understand collections, and that is capable of performing collection-aware operations. In essence, a CSS system is similar to a prior art CM system, except that a CSS system understands inventive collection data structures and associated inventive methods for performing collection-aware operations. Understanding collections gives CSS systems a significant practical advantage in their representational and functional usefulness to people and programs that work with collections.

The CSS system shown in FIG. 7 is comprised of a CSS client module 115 and a CSS server module 116. Both client and server modules can perform non-collection aware operations using a software operations module Do Non-Collection Operations Means 112 that does not understand collection operations. But both client and server can perform collection-aware operations using a software operations module Collection Storage Operation Manager Means 117 that can perform collection-aware storage operations.

The next section describes how the collections in the tree of FIG. 4 might be stored and referenced within a collection storage system, using collection reference expressions.

Introduction to Collection References

Collections are useful and practical software containers for computer files because collections make it much easier for people to work on whole sets of related computer files with simple commands. Computer programs can work with collections too, but the programs must usually know where collections are physically located on a filesystem before performing operations on the collections.

In particular, computer programs can work on collections most easily if the programs are invoked in a working directory that is contained within a proper collection directory structure that contains a collection specifier file. In contrast, automated computer programs cannot easily reference collections from a working directory that is outside a collection, because a suitable referencing means is required for referencing external collections. For example, an automated program that is invoked inside a directory inside a collection can effectively refer to “this collection,” but there is no easy way of saying “that collection over there” except by using a long filesystem pathname. The restriction of always being forced to work on collections from within local collection directory structures is a significant limitation in processing flexibility.

Collection storage systems and collection references overcome this limitation by enabling people and programs to refer to collections that are stored within a collection storage system. Such an arrangement allows people to refer to collections by unique symbolic name, thereby saving themselves the effort of remembering and typing in long pathnames that are likely to change.

Several different kinds of collection references are possible. To show the underlying technical structure of collection references, the following discussion starts with definitions for simple expressions and builds up to definitions and examples of full collection references.

Expressions are comprised of sequences of characters. Expressions have no meaning until a human or program interprets them with respect to a set of interpretation rules. For example, numeric expressions are comprised of numbers, alphabetic expressions are comprised of letters, and alphanumeric expressions are comprised of both letters and numbers.

References are comprised of expressions that refer to something when humans or programs interpret expressions with respect to a set of interpretation rules. For the sake of convenience, humans often name or classify references according to either the syntactic form of the reference or according to the target of the reference (the referent). For example, here are some examples of references that are named after the syntactic form of the reference: numeric references, pointer references, HTTP URL references, and FTP references. In contrast, here are some examples of references that are named after the things that are pointed to by the reference: document references, file references, and collection references.

Collection References are comprised of expressions that, when interpreted, refer to collections. Collection references can refer to collections in three ways: by location (that is, by pathnames), by internal collection properties such as collection type (“all web page collections”), or by symbolic name (“mycollection:mysite.com”). Each of these three collection reference methods is described in more detail below.

First, references to collections by location are references to file folders or directories in computer file systems. This method works because collections are normally stored in file folders or hierarchical directory structures in computer file systems. The content of a directory structure, including the presence of a valid collection specifier, ultimately determines whether a directory actually contains a collection.

Second, references to collections by internal properties such as collection type are usually search expressions that programs use to find and select interesting collections from a group of collections for processing. For example, a searcher might want to refer to all collections of a particular collection type within a collection namespace or within a computer file system.

Third, references to collections by name only have meaning within collection namespaces that are defined by humans or application programs that manage entries in the namespace. For example, a configuration management system that understood collections would specify a particular syntax for referring to collections by name within the managed namespace.

Here is one practical example of a collection reference name syntax: “<category>:<authority>:<collection>.” The first category part of the name is a hierarchical expression that categorizes collections into large groups within a collection namespace. The second authority part is the name of a network authority (usually an Internet hostname such as hostname.mysite.com) that manages a collection namespace. The third collection part is the name of a specific collection, within the category, within the collection namespace, that is managed by the authority.

The present Collection Symbolic Job Expander invention uses the third collection referencing method, collection reference by name, including the “<category>:<authority>:<collection>” syntax described above. Collection references by name are much more convenient than are collection references by type or by properties.

Need for Shortcut Collection References

Shortcut Collection References are convenient, short-form collection name references that reduce typing effort and reduce knowledge burdens on human users. The main idea of shortcut references is that people can save typing by omitting various parts of a normal collection reference. Application programs can fill in missing parts of a shortcut reference by using default values from a current local working collection, or by using default values that are specified by the application program itself.

The next section describes the syntax of both complete and shortcut collection references.

Collection Reference Representations

FIGS. 8-10 show several formats for collection references and shortcut references.

FIG. 8 shows the structure of a complete collection reference. FIG. 8 Line 3 shows three major syntactic components of a preferred implementation of a complete collection reference—a collection reference name (category:authority:collection), a set of scoping arguments, and a set of content selector arguments. The first component, a collection reference name, is mandatory. The other two components, scoping arguments and content selector arguments, are optional.

A collection reference name is comprised of three parts—a category name, an authority name, and a collection name. A category name is a hierarchically structured name that groups related collections into categories, just as directory folders group related computer files into directories. An authority name is the name of an authority that is responsible for managing a collection. In practice, an authority name is an Internet Domain Name of a host computer that executes a server program for managing collections. A collection name is the name of a collection.

A collection reference scoping argument modifies a collection reference to refer to particular portions of a whole collection. For example, a “-recursive” scoping argument indicates that a reference should recursively include all directories and filenames below the recursion starting directory. Other examples of scoping arguments include “-new,” “-changed,” “-old,” “-local,” “-remote,” and “-locked.” In a collection storage system, these scoping arguments limit the scope of a collection reference to particular directories and filenames by comparing a local collection copy with a remote authoritative collection copy. Scoping arguments enable people to reference only the collection directories and files that interest them.

A collection reference content selector is a particular category, directory, or filename that limits a collection reference to include particular named categories, directories, or filenames. Collection reference content selectors act like collection reference scoping arguments, to limit the scope of a collection reference. But whereas scoping arguments use properties of collection elements (such as new, locked, changed) to limit collection references, content selectors use explicit names of collection content members to limit a collection reference.

FIG. 9 shows an example collection reference that is a normal “whole collection” reference for the collection shown in FIG. 2. Keep in mind that the syntax shown (“category:authority:collection-name”) is a collection reference that has meaning only within a collection namespace that is managed by a collection storage system

Representation of Shortcut Collection References

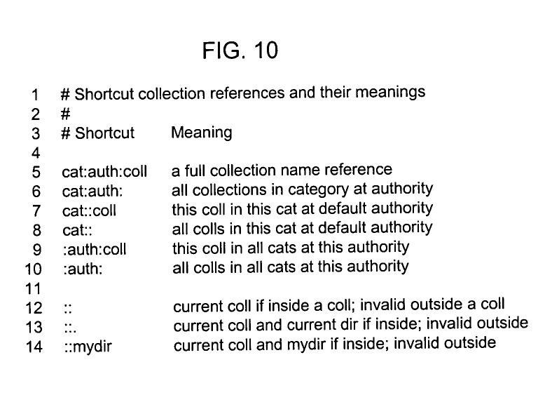

FIG. 10 shows a table of shortcut collection references and their meanings. A shortcut collection reference omits one or more parts of a normal three-part collection reference name. For example, FIG. 10 Line 6 shows a shortcut reference that omits the third component of a collection reference name, and thereby refers to “all collections” in a specified category at a specified authority.

Shortcut collection references are very useful in practice. They save typing. They reduce reference errors. They provide increased referencing power. They provide flexibility for referencing multiple categories of collections, authorities, and individual collections. Indeed, shortcut collection references have more referential power than complete three-part collection reference names. This is because complete collection names must provide specific values for a category and a collection, and so cannot refer to all categories, or all collections.

One of the functions of the present Collection Symbolic Job Expander invention is to expand shortcut collection references within symbolic job requests into lists of complete three-part collection reference names.

Local and Remote Collection References

FIG. 10 also shows both local and remote collection references. Lines 12-14 show local collection references, and Lines 5-10 show remote collection references.

Local Collection References refer to a current working collection. A current working collection for a program that is making a local collection reference is defined to contain the working directory of the program. Local collection references have no meaning, and are invalid, if no collection contains the working directory of a computer program that is making a local collection reference. In the examples presented in this disclosure, local collection references begin with a double colon “::” as shown in FIG. 10 Lines 12-14. Other syntaxes are also possible, and would be determined by the collection storage system that manages the namespace.

Remote Collection References do not require that a program's current working directory be within a collection directory structure. A valid remote collection reference can be made from within any file system directory, whether inside or outside of a collection directory structure. Remote collection references are interpreted by programs that manage access to a set of collections, such as a collection storage system. In the examples presented in this disclosure, remote collection references do not start with a double colon “::” character sequence. Other syntaxes are also possible, as determined by the implementation policies of host collection storage systems.

FIG. 10 Line 14 shows a reference that could be construed as a remote reference that means “all categories at all authorities that contain a collection called ‘mydir’.” This interpretation is legitimate because it is in accordance with the conventions that have been presented above for remote collection references. But that is not the meaning used in this disclosure. Instead, it is more advantageous to use this particular syntax (“::dir”) to refer to local partial collections, for two reasons. First, this syntax is rarely, if ever, used for remote references in practice. Second, the double colon at the beginning of the reference makes it look like a local reference, so it would cause confusion among users if it were used as a remote reference. For these reasons, preferred implementations treat the syntax (“::dir”) as a local collection reference.

Keep in mind that the interpretation of a collection reference is ultimately determined by the implementation policies of the computer program that interprets the reference. This is why other syntaxes are also possible. For example, an application program could specify that local collection references should begin with a double sequence of a non-colon character such as “x.” Then the three shortcut local references shown in FIG. 10 Lines 12-14 would be “xx” “xx<dot>” and “xxdir” (where <dot> means a period). Or a slash could be used, giving “//” “//<dot>” and “//dir.” This disclosure, which explains a preferred implementation, uses double colons for shortcut local collection references, to maintain a consistent look among all collection references. But other implementations are also possible.

Symbolic Job Requests

Having described collections, collection storage systems, and collection references to reference sets of collections within a namespace that is managed by a collection storage system, we now turn our attention to collection symbolic job requests.

The following sections describe collection symbolic job requests and a format for expanded job lists. Finally, we explain how the present Collection Symbolic Job Expander uses inventive structures and methods to carry out the required job expansions.

Once the inputs and outputs of a job expansion process have been shown, a detailed explanation of the expansion process will be provided.

Collection Symbolic Job Requests

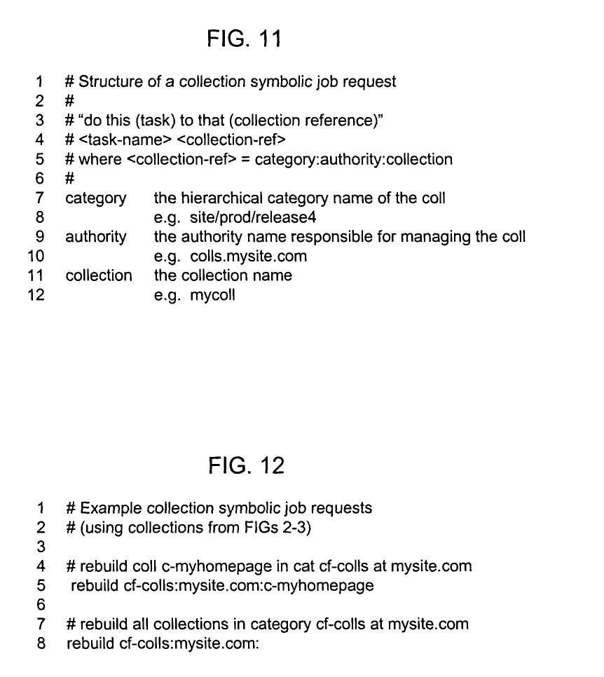

FIG. 11 shows the structure of a collection symbolic job request. The intent of a symbolic job request is to make it easy for humans to apply operations to large groups of collections, without having to specify tedious processing details such as particular collection names, processing visit orders, or processing platform names.

A collection symbolic job request has two parts: a symbolic task name and a collection reference name. FIG. 11 Line 4 shows the syntactic structure of a two-part collection symbolic job request.

A symbolic task name is the name of an operation that should be performed by the computer program that carries out the symbolic job request. Arbitrary operations and operation names are possible, limited only by the capabilities of the job processing system. For example, task names could include “checkout,” “compile,” “rebuild,” “regression-test,” and “install.”

A collection reference name is comprised of three parts—a category name, an authority name, and a collection name. As discussed previously, collection reference names can be shortcut reference names, and can refer to individual collections or sets of collections within a managed collection namespace.

FIG. 12 shows two example collection symbolic job requests. FIG. 12 Line 5 shows a request to rebuild an individual collection “cf-colls:mysite.com:c-myhomepage.” FIG. 12 Line 8 shows a request to rebuild all collections in category “cf-colls” in the collection namespace managed by authority “mysite.com.”

The main job of a Collection Symbolic Job Expander is to expand a symbolic job request such as FIG. 12 Line 8 into a list of more detailed job requests that contain specific collection names, visit orders, and processing platform names.

Collection Reference Name Expansion

The first step in performing a collection symbolic job request expansion is to expand shortcut collection reference expressions (that symbolically reference a set of collections) into a list of individual, specific collection names.

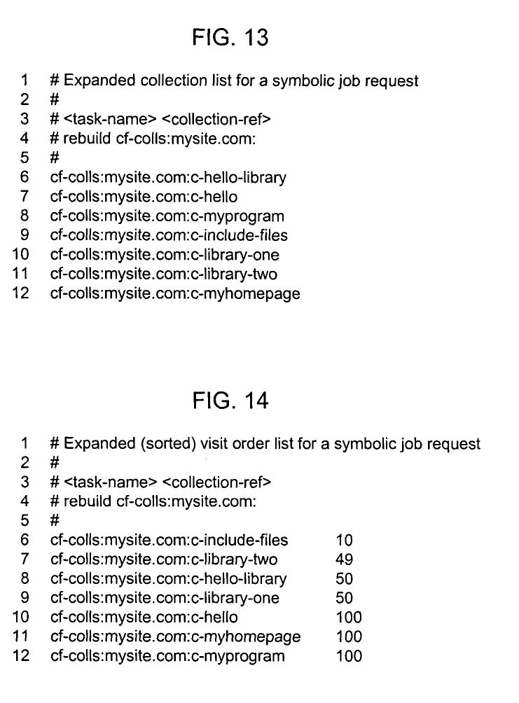

FIG. 13 shows the results of a collection reference name expansion. Line 3 reiterates the syntactic structure of a collection symbolic job request. Line 4 shows an example symbolic job request to rebuild all collections in category “cf-colls” in the collection namespace managed by authority “mysite.com.” By intent, FIG. 4 shows one possible filesystem structure that a collection storage system might use to represent the collections indicated by the shortcut reference “cf-colls:mysite.com.”

FIG. 13 Lines 6-12 show an expanded list of individual collection names for the collection symbolic job request of FIG. 13 Line 4. Individual collection names in Lines 6-12 happen to appear in the same vertical order as shown in FIG. 4, but no strong ordering is either intended or necessary for this part of the job expansion process. Proper visit ordering is a separate step in the expansion process.

Details of collection reference name expansions appear later in this document.

Visit Order Expansion

Once a list of individual collection names has been calculated from a shortcut reference in a symbolic job request, a proper visit ordering must be calculated to ensure that individual collections are processed (“visited”) in the desired order.

FIG. 14 shows the results of a visit order expansion. Line 4 shows the original symbolic job request.

Lines 6-12 Column 1 shows the list of individual collection names that resulted from expanding the shortcut collection reference name of Line 4 Column 2.

Lines 6-12 Column 2 shows a list of visit order ranking values associated with the collections names of Column 1. Lines 6-12 have been sorted into proper visit order, according to the visit order values in Column 2.

As can be seen, the sorted order of individual collection names FIG. 14 Lines 6-12 is not the same as the original list of collection names FIG. 13 Lines 6-12. This is because the original list of collection names was not in proper visiting order.

A detailed explanation of visit order expansions is provided later in this document.

Platform Expansion

The third step in the symbolic job expansion process is to expand the list of individual collections by processing platform name. Recall that it may be necessary to perform the original symbolic task operation on each collection in the list, on multiple computing platforms. For example, source code files for a computer application program might have to be compiled for several popular personal computer operating systems (platforms).

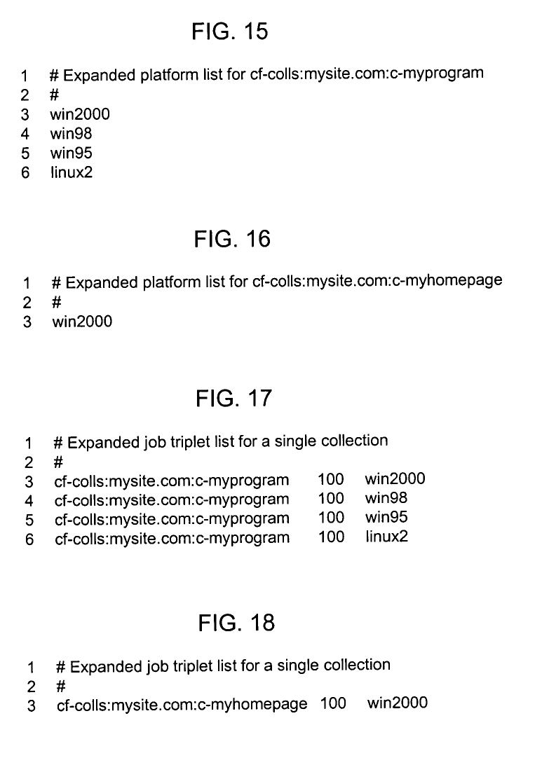

FIG. 15 shows a list of four user-defined computing platform names (these are not trademarked names, they are user-defined names). Line 1 shows the name of a collection “cf-colls:mysite.com:c-myprogram” for which the list of platform names was determined.

FIG. 16 shows a list of one computer platform, this time for a different collection. Line 1 shows the name of a collection “cf-colls:mysite.com:c-myhomepage” for which the list of one platform name was determined.

FIGS. 15-16 are an example of the principle that different collections can be processed on different sets of computing platforms. Accordingly, collection symbolic job expanders must be capable of producing different sets of platform lists for different collections.

Expanded Job Triplets

Once visit order and platform expansion values have been determined for an individual collection name, all three values are organized into a “job triplet” that specifies detailed processing information for one individual collection. Ultimately, all triplets for all collections in an expansion are organized into a list that is the output of a collection symbolic job expansion process.

FIG. 17 shows the results of a collection reference, a visit order, and a platform expansion for a single collection “cf-colls:mysite.com:c-myprogram.” Lines 3-6 show four expanded job triplet lines because four user-defined computing platforms are required for this particular collection (win2000, win98, win95, linux2).

FIG. 18 shows the results of a collection reference, visit order, and platform expansion for a single collection “cf-colls:mysite.com:c-myhomepage.” Only one expanded job triplet line is required because this particular collection only requires processing on one user-defined computing platform name (win2000).

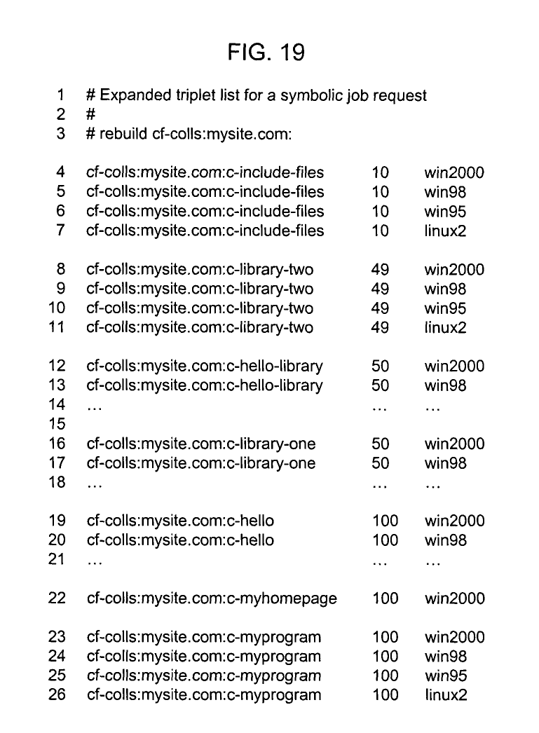

FIG. 19 shows the results of a collection reference, a visit order, and a platform expansion for the original symbolic job request of FIG. 12 Line 8 and FIG. 13 Line 4. FIG. 19 Line 3 shows the original symbolic job request. FIG. 19 Lines 4-26 show a list of job triplets for all collections indicated by the shortcut collection reference in the original symbolic job request. Some triplets Lines 14, 18, 21 have not been shown because of space limitations. Ellipsis characters indicate missing triplets.

Job Expander Data Structures

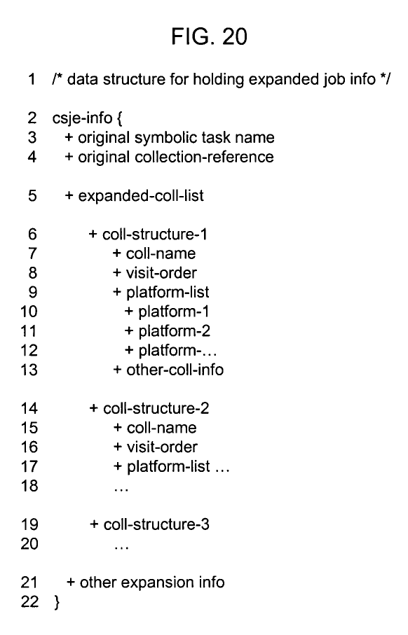

FIG. 20 shows an inventive data structure for holding collection symbolic job expansion information. Line 3 holds the name of an input symbolic processing task, which is associated with all collections in the data structure (there is no need to have N copies of the same symbolic task name in one data structure). Line 4 holds the name of an input (possibly shortcut) collection reference. Lines 5-20 hold a list of expanded collection names and associated triplet information.

FIG. 20 Lines 6-13 hold expansion information for an individual collection. Line 7 holds a single expanded collection name. Line 8 holds a visit order ranking value for the collection. Line 9 holds a list of platform names for the collection. Lines 10-12 hold particular platform names for the collection. Line 13 holds other information that might be required by a particular implementation of the collection symbolic job expander principles set forth in this document.

Job Expander Enabled Application Programs

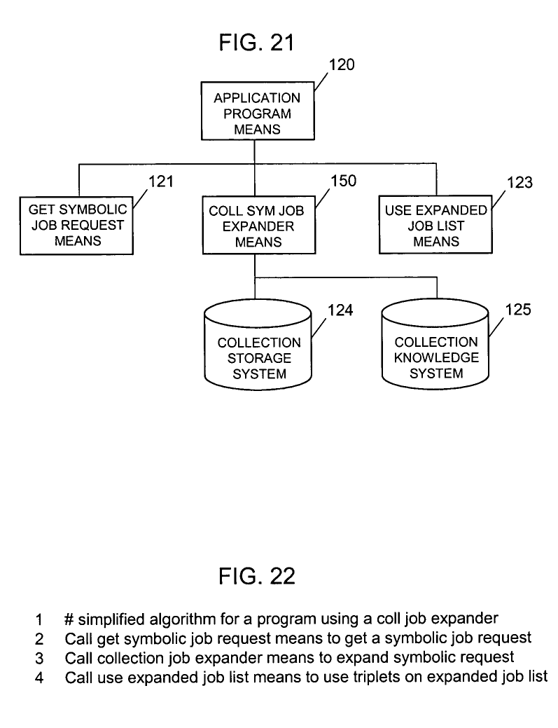

FIG. 21 shows a simplified architecture for an application program means 120 that uses a module Collection Symbolic Job Expander Means 150 to expand symbolic job requests into expanded job triplet lists.

Module Application Program Means 120 is a collection-enabled application program that works with collections and that uses collection symbolic job references.

Module Get Symbolic Job Request Means 121 obtains a collection symbolic job request using normal software means known to the prior art. For example, the module might get a job request from a command line invocation, by reading a job request from a network connection, by reading a job request from a file or database, or by calculating a symbolic job request from other existing data values known to the program.

Module Collection Symbolic Job Expander Means 150 expands incoming symbolic job references into lists of more detailed job triplets that contain individual collection names, visit order values, and processing platform names. Expanded job requests contain sufficient processing information to be executed or otherwise processed by a module Use Expanded Job List Means 123.

Module Use Expanded Job List Means 123 uses the expanded symbolic job request to carry out the processing purposes of the Application Program Means 120. For example, the application program might perform an operation on a collection named in the expanded job request list, or it might pass on the expanded job request data to a database or to another computer program.

FIG. 22 shows a simplified algorithm for an Application Program Means 120 that uses a module Collection Symbolic Job Expander Means 150 to expand incoming symbolic job requests.

In operation, an Application Program Means 120 obtains a collection symbolic job request from module Get Symbolic Job Request means 121. Next, Application Program Means 120 calls module Collection Symbolic Job Expander Means 150 to carry out a job expansion action on the incoming symbolic job request. Finally, Application Program Means 120 passes the expanded job list results to module Use Expanded Job List Means 123, which carries out the purpose and function of the application program.

Module Collection Symbolic Job Expander Means 150 uses information from two auxiliary systems during expansion actions. First, it uses a Collection Storage System 124 to help expand shortcut collection references and to obtain collection type information for individual collections in the expanded collection list. Second, it uses a Collection Knowledge System 125 to obtain visit order values and processing platform lists for particular collection types.

See the list of related patent applications at the front of this document for more information on Collection Storage Systems.

See the list of related patent applications at the front of this document for more information on Collection Knowledge Systems.

Any module in a collection-aware software system can use the services of a Collection Knowledge System 125 to obtain information relevant to collections that are being processed.

Job Expander Enabled Collection Processing Systems

As a second example of a practical application of collection symbolic job expanders in the technical arts, we now turn our attention to Collection Processing Systems (CPS) that carry out symbolic job requests.

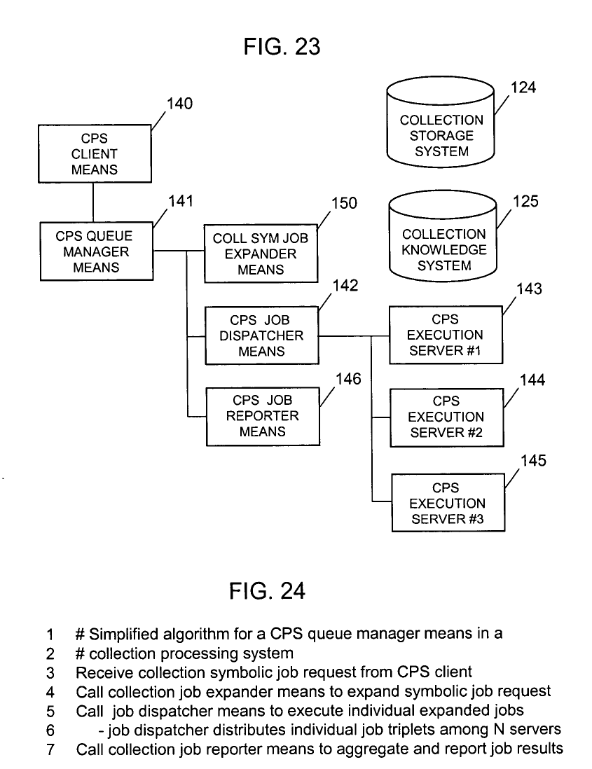

FIG. 23 shows a simplified architecture for a collection processing system that uses a module Collection Symbolic Job Expander Means 150 to expand symbolic job requests into expanded job triplet lists that contain enough information to support execution on CPS execution server programs.

Module CPS. Client Means 140 obtains a collection symbolic job request using normal software means known to the prior art. For example, the module might get a job request from a command line invocation, by reading a job request from a network connection, by reading a job request from a file or database, or by calculating a symbolic job request from other existing data values known to the program.

Module CPS Queue Manager Means 141 receives incoming symbolic job requests from CPS Client Means 140, enqueues the requests on a job queue, and then manages the subsequent expansion, dispatch, and reporting activities associated with each job request. Module Collection Symbolic Job Expander Means 150 expands incoming symbolic job references into lists of more detailed job triplets that contain individual collection names, visit order values, and processing platform names. Expanded job requests contain sufficient processing information to be executed or otherwise processed by modules CPS Execution Servers 143-145.

Module CPS Job Dispatcher Means 142 obtains pending job requests from CPS Queue Manager Means 141, and dispatches them to CPS Execution Servers 143-145. Proper visit ordering is preserved during job dispatching, so that all detailed job triplets within one visit order rank are completed before any job triplets in the next sequential visit order rank are begun. CPS Job Dispatcher Means 142 converts job triplet information into an intermediate form before sending converted job information to CPS Execution Servers 160 for execution.

Modules CPS Execution Servers 143-145 receive detailed job triplet requests from CPS Job Dispatcher Means 142, and then carry out the requested task operations on the individual collection as specified in the detailed job triplet request. Execution results are reported back to CPS Job Dispatcher Means 142 for aggregation, formatting, and reporting.

Module CPS Job Reporter Means 146 obtains accumulated job triplet results for a single collection symbolic job request, aggregates and formats the results, and then reports final results for each symbolic job request. Note that the results for one symbolic job request may include results from many expanded job triplet requests. Collection Storage System 124 and Collection Knowledge System 125 are auxiliary systems used by the collection processing system shown in FIG. 23. See the list of related patent applications at the front of this document for more information on these two auxiliary systems.

FIG. 24 shows a simplified algorithm for the collection processing system shown in FIG. 23.

In operation, CPS Queue Manager Means 141 receives incoming symbolic job requests from CPS Client Means 140. Symbolic job requests are enqueued on a job list to properly manage incoming job requests.

CPS Queue Manager Means 141 calls Collection Symbolic Job Expander Means 150 to expand symbolic job requests into lists of more detailed job triplets, in preparation for job triplet execution. Expanded lists of job triplets are also enqueued on the job list, taking the place of the original symbolic job request. This replacement action preserves original job priority relationships within the job queue.

CPS Queue Manager Means 141 calls CPS Job Dispatcher Means 142 to dispatch individual job triplet requests to particular CPS Execution Servers 143-145. The job dispatching action distributes multiple job triplet requests over multiple execution servers, according to visit order ranking, available execution servers, and computing platform matches between job triplets and execution servers. Parallel, multiplatform processing of symbolic job requests is thereby obtained.

CPS Execution Server Means 143-145 carry out the computations required by individual job triplet requests. Each CPS Execution Server Means 143-145 supports job triplet requests for one particular processing platform.

CPS Queue Manager Means 141 finally calls CPS Job Reporter Means 146 to aggregate, format, and report the results of symbolic job requests. As a matter of convenience, results can be reported for symbolic job requests, for individual job triplet requests, for only failed individual job requests, or for other subsets of the original symbolic job request. Those skilled in the programming art will appreciate that many different reporting possibilities and options are possible.

During operation, modules in a collection processing system FIG. 23 make calls to a Collection Storage System 124 and a Collection Knowledge System 125 whenever they need the services of these two auxiliary systems.

It should be noted that although these two systems are called “auxiliary” here, they perform essential supporting functions to the present Collection Symbolic Job Expander invention. They have been called auxiliary systems because they are typically implemented as external, standalone systems that can be used by other application programs and systems beyond the examples described here.

Collection Symbolic Job Expander Means

Having now described collections, collection references, collection symbolic job requests, the information content of desired expansion outputs, and the architecture and operation of two practical examples of collection job expansion applications, we now turn our attention to a detailed explanation of the inventive structures and methods of the present Collection Symbolic Job Expander invention.

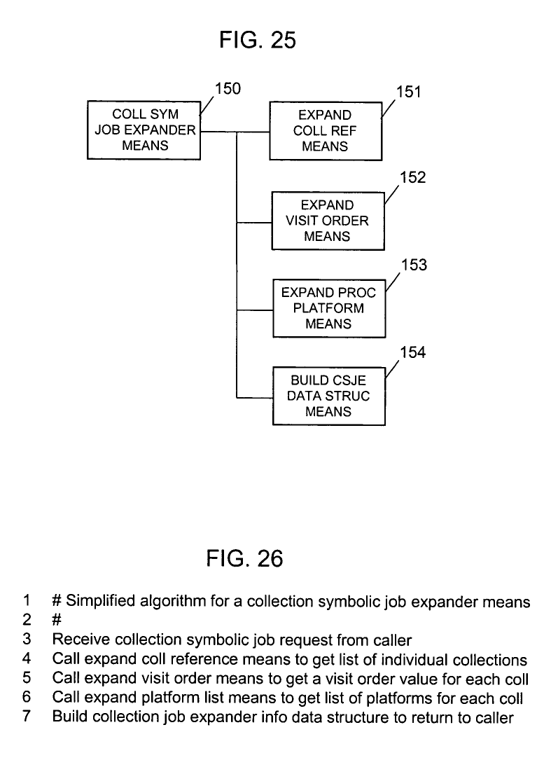

FIG. 25 shows a simplified architecture of a Collection Symbolic Job Expander Means 150. Several subordinate modules 151-154 help to carry out the function of module Collection Symbolic Job Expander Means 150.

Module Expand Collection Reference Means 151 expands an incoming shortcut collection reference into a list of individual collection reference names. If an incoming collection reference already refers to an individual collection, no expansion action is required.

Module Expand Visit Order Means 152 associates a visit order ranking value with each individual collection on the list of collection names produced by module Expand Collection Reference Means 151. To perform this expansion, module Expand Visit Order Means 152 uses a collection type obtained from a Collection Storage System 124, and visit order ranking values from a Collection Knowledge System 125.

Module Expand Processing Platform Means 153 associates a list of processing platforms with each individual collection on the list of collection names produced by module Expand Collection Reference Means 151. To perform this expansion, module

Expand Processing Platform Means 153 uses a collection type obtained from a Collection Storage System 124, and processing platform lists from a Collection Knowledge System 125.

Module Build CSJE Data Structure Means 154 is a helper module that manages additions to the data structure shown in FIG. 20. Those skilled in the programming arts will recognize this module as a utility module for adding information to a complex data structure, and will recognize that there are other equivalent alternatives for performing the function of this module.

In particular, Build CSJE Data Structure Means 154 is responsible for propagating an original incoming task name FIG. 11 Line 4 Column 1, FIG. 12 Line 5 Column 1 “rebuild” to each expanded job triplet list. Those skilled in the programming arts will recognize that this is a trivial function to perform, and that storing a single instance of the task name in a data structure FIG. 20 Line 3 is equivalent to storing a separate instance of the same task name with each distinct job triplet FIG. 20 Lines 6, 9, 14.

FIG. 26 shows a simplified algorithm for a module Collection Symbolic Job Expander Means 150.

In operation, Collection Symbolic Job Expander Means 150 receives a symbolic job request from a caller module, and passes the incoming symbolic job request to Expand Collection Reference Means 151 to expand shortcut collection references into a list of individual collection names, as shown in FIG. 13.

Next, Collection Symbolic Job Expander Means 150 passes the expanded list of individual collection names to module Expand Visit Order Means 152 to determine a visit order rank for each individual collection name on the list. Expand Visit Order Means 152 returns a sorted list of individual collection names and visit order values, as shown in FIG. 14.

Next, Collection Symbolic Job Expander Means 150 calls module Expand Processing Platform Means 153 to further expand the list of visit-order-ranked collection names with processing platform names, as shown in FIG. 19.

Finally, Collection Symbolic Job Expander Means 150 calls module Build CSJE Data Structure Means 154 to organize all expansion information into a convenient data structure, as shown in FIG. 20. Those skilled in the art will easily recognize that there are many possible ways to organize the expansion information other than the example organization shown in FIG. 20.

Expand Collection Reference Means

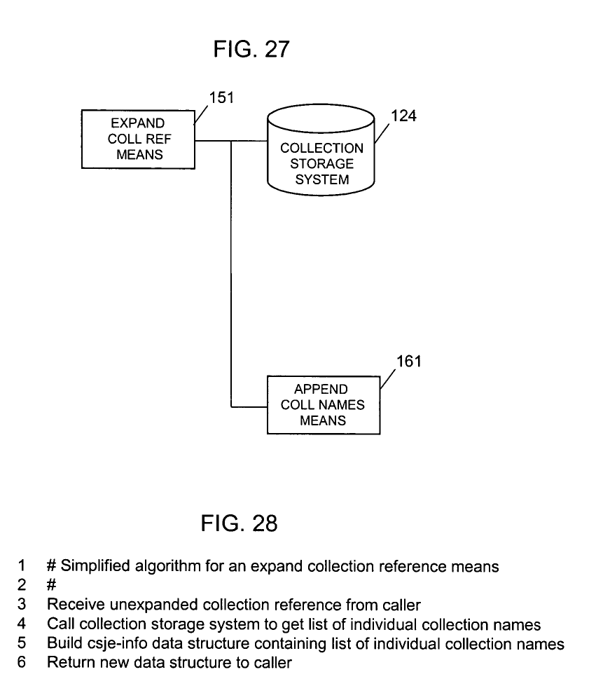

FIG. 27 shows a simplified architecture for a module Expand Collection Reference Means 151. Two other modules help to carry out the function of Expand Collection Reference Means 151.

Collection Storage System 124 interprets incoming shortcut reference names within the collection namespace that is managed by the storage system, and provides a list of individual collection names that match the incoming shortcut expression.

Module Append Collection Name Means 161 is a utility module that appends the expanded list of individual collection names into a list or data structure that can be returned to the caller of Expand Collection Reference Means 151. The data structure involved may be similar to the one shown in FIG. 20.

FIG. 28 shows a simplified algorithm for a module Expand Collection Reference Means 150.

In operation, module Expand Collection Reference Means 151 receives a collection reference expression from its caller module. The incoming collection reference expression may be a shortcut reference, as shown in FIG. 10.

To expand the incoming collection reference, module Expand Collection Reference Means 151 passes the incoming reference to a Collection Storage System 124 for interpretation.

Recall that since collection reference names refer to sets of collections within a collection namespace that is managed by a suitable computer program, only the namespace manager program can know how to properly interpret a shortcut collection reference for a particular namespace. Only the namespace manager can provide an authoritative list of individual collection names that are the expansion of the incoming shortcut reference name.

To organize the list of expanded individual collection names returned by Collection Storage System 124, module Expand Collection Reference Means 151 calls utility module Append Collection Name Means 161. This utility module converts, organizes, formats, or otherwise places the list of individual names into a data structure that can be returned to the caller of Expand Collection Reference Means 150, for use in other steps of the job request expansion process.

Expand Visit Order Means

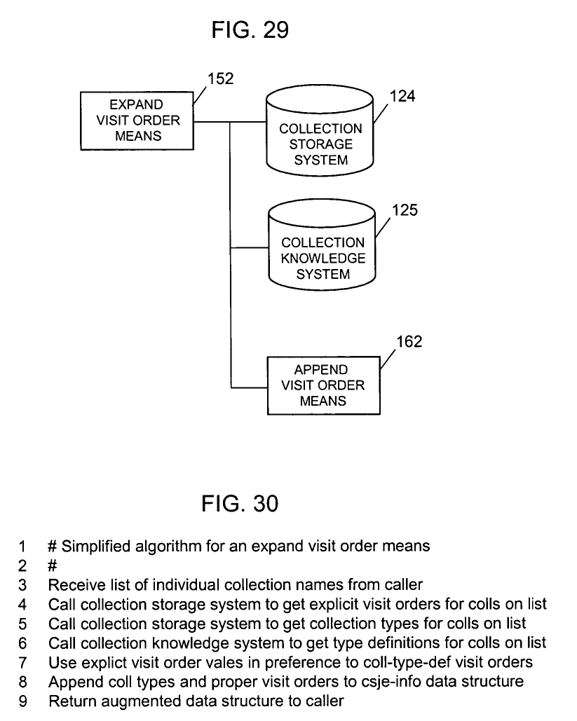

FIG. 29 shows a simplified architecture for a module Expand Visit Order Means 152. Several other software modules help to carry out the function of Expand Visit Order Visit Means 151.

Collection Storage System 124 provides collection type values for collection names on the expanded list of individual collection names produced by Expand Collection Reference Means 151.

Collection Knowledge System 125 provides default visit order rank values for collection types provided by Collection Storage System 124.

Module Append Visit Order Means 162 a utility module that appends visit order values to the expanded list of individual collection names, as shown in FIG. 14. Visit order values may also be appended to a data structure such as the one shown in FIG. 20.

FIG. 30 shows a simplified algorithm for a module Expand Visit Order Means 152.

In operation, module Expand Visit Order Means 152 receives an expanded list of individual collection names from its caller module. For each collection name on the list, Expand Visit Order Means 152 first obtains explicit visit order rank values and collection type values from a Collection Storage System 124.

Next, Expand Visit Order Means 152 passes the list of collection type values to a Collection Knowledge System 125 to obtain a corresponding list of collection type definitions and default visit order values. Using the list of explicit visit order values, and the lists of collection types and default visit order values, Expand Visit Order Means 152 calculates a complete list of visit order values for the list of expanded collection names, one visit order value per collection name on the list.

Explicit visit order values take precedence over default visit order values, so that people can give particular visit order rankings to particular collections, regardless of collection types and default visit order values. Details of visit order data structures and lookup operations are provided below.

Next, Expand Visit Order Means 152 appends the final list of visit order values to a suitable data structure by calling module Append Visit Order Means 162. This utility module organizes and appends new visit order values to the incoming list of collection names, and sorts the resulting list, as shown in FIG. 14. Module Expand Visit Order Means may append visit order data to a data structure such as the one shown in FIG. 20.

Determining Default Visit Order Values

Expand Visit Order Means 152 determines default visit order values as follows.

First, Expand Visit Order Means 152 passes an expanded list of individual collection names to Collection Storage System 124. For each collection name on the list, Collection Storage System 124 looks in the corresponding collection specifier file 102 to obtain a corresponding collection type value.

FIG. 3 shows a typical collection specifier file for a collection stored in a Collection Storage System. Line 2 shows a collection type value “cf-web-page” for this example collection. Collection Storage System 124 would fetch and return this collection type to Expand Visit Order Means 152.

Next, we describe a typical lookup sequence that would be executed to obtain a default visit order value for a particular collection type.

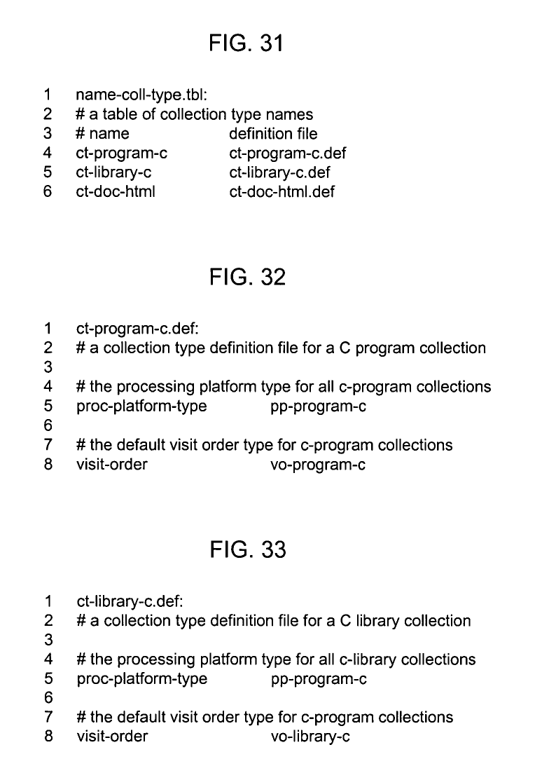

FIG. 31 shows a collection name table that would typically be stored in a Collection Knowledge System 125. Column 1 of the table contains collection type names and Column 2 of the table contains corresponding collection type definition filenames. Collection type definition files are also stored in a Collection Knowledge System 125.

Suppose Module Expand Visit Order Means 152 calls Collection Storage System 124 to obtain collection types for collections on the expanded list of individual collection names. Suppose also that one of the collection types returned by Collection Storage System 124 was “ct-program-c.”

Expand Visit Order Means 152 would use the collection type “ct-program-c” as a lookup key into the collection type table FIG. 31 that was stored in a Collection Knowledge System 125. A match would be found on Line 4 Column 1, yielding the name of a collection type definition file “ct-program-c.def” from Column 2.

FIG. 32 shows an example collection type definition file for a collection type “ct-program-c.” Lines 7-8 show the default visit order value “vo-program-c” for this type of collection.

FIG. 33 shows an example collection type definition file for a collection type “ct-library-c.” Lines 7-8 show a different default visit order value “vo-library-c” for this type of collection.

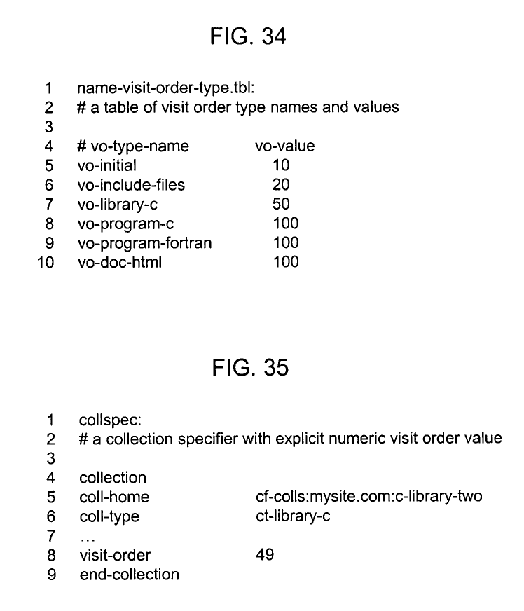

FIG. 34 shows a default visit order value table such as would be stored in a Collection Knowledge System 125. Column 1 contains symbolic visit order value names, and Column 2 contains corresponding numeric values that establish visit order ranking positions. FIG. 34 Line 8 “vo-program-c” shows a default visit order rank of 100 for C programs, and FIG. 34 Line 7 shows a default visit order rank of 50 for C libraries.

From FIGS. 31-34, those skilled in the art can see a lookup path that proceeds as follows. A collection name on a list of collection names is used to obtain a collection type from a Collection Storage System. Then the obtained collection type is looked up in a collection type name table FIG. 31 to obtain a collection type definition file FIG. 32. A visit order value from a collection type definition FIG. 32 Line 8 is used as a lookup key into a default visit order value table FIG. 34 to obtain a numeric visit order rank. This is how default numeric visit order ranks are determined for each individual collection name on a list of expanded collection names.

Next, we consider the representation and use of explicit visit order values.

Determining Explicit Visit Order Values

Default visit order values are not always sufficient to determine a correct visit order for processing collections in a symbolic job request. This is because “special case” processing requirements often demand that particular collections be processed before their other peer collections, even though all peer collections have the same default visit order rank.

For a practical example, one or two important link libraries might have to be processed before other peer libraries, because of processing dependencies that cannot be represented using other means. As another example, people might want to whimsically process one web page collection before all other web page collections, even though the collections involved can be properly processed completely independent of one another. Those skilled in the art are probably familiar with various kinds of special visit ordering scenarios from their own experience, and could easily imagine others.

The problem to be solved is how to represent and control special visit ordering requirements on particular collections, regardless of their collection types. The solution described here uses explicit visit order values that are stored in collection specifier files 102, along with the usual collection type values.

FIG. 35 shows an example collection specifier file “collspec” for the collection named “c-library-two” shown in FIG. 4 Line 10.

FIG. 35 Line 6 shows a collection type value of “ct-library-c,” which corresponds to a default visit order value of “50” as shown in FIG. 34 Line 7. The lookup chain from collection type to numeric value using FIGS. 31, 32, and 34 was explained above.

However, FIG. 35 Line 8 also shows an explicit visit order value of “49” for this particular collection instance, which overrides the default value of “50.” Therefore this collection “c-library-two” FIG. 4 Line 10 should be processed before all other library collections that have a default visit order value of 50.

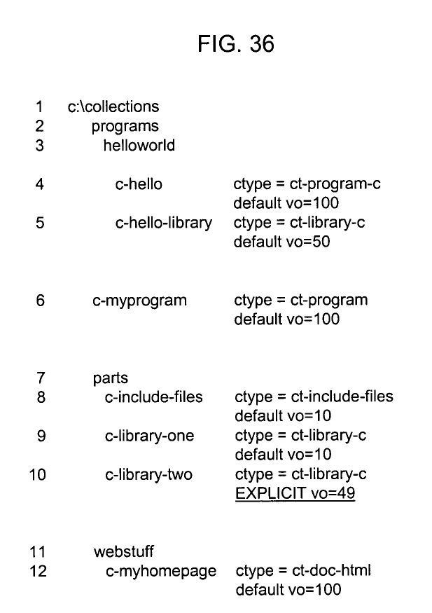

FIG. 36 shows visit order values for the collections shown in the tree of FIG. 4. Default visit order values are shown for all collections except for collection “c-library-two,” which shows an explicit visit order value of “49” from collection specifier FIG. 35 Line 8.

Explicit visit order values stored within a collection specifier file take precedence over default visit order values that are established by collection types.

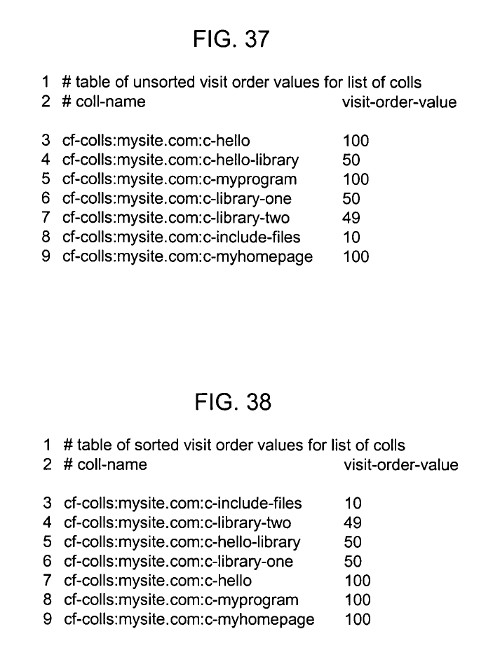

FIG. 37 shows an unsorted list of individual collection names and visit order rankings.

FIG. 38 shows a list of individual collection names, sorted by visit order rankings. Note that collection “c-library-two” FIG. 38 Line 4 has an explicit visit order value of “49.” This means that “c-library-two” will be processed before the other two libraries Lines 5-6 that have default visit order values of “50” in the list.

Returning now to the simplified algorithm for Expand Visit Order Means 152 shown in FIG. 30, readers can understand why Line 4 (obtain explicit visit order values) and Line 7 (explicit values override default values) are present in the algorithm.

Explicit visit order values have very practical applications in technical arts that are concerned with automatically processing large number of collections. In particular, the inventive default and explicit visit order calculation means that was described here enables automated collection processing systems to correctly determine and enforce particular collection processing orders, with no human labor involved.

Expand Processing Platform Means

Having described expansion of collection references and visit orders, we now describe the final major step in expanding symbolic job requests, processing platform expansion.

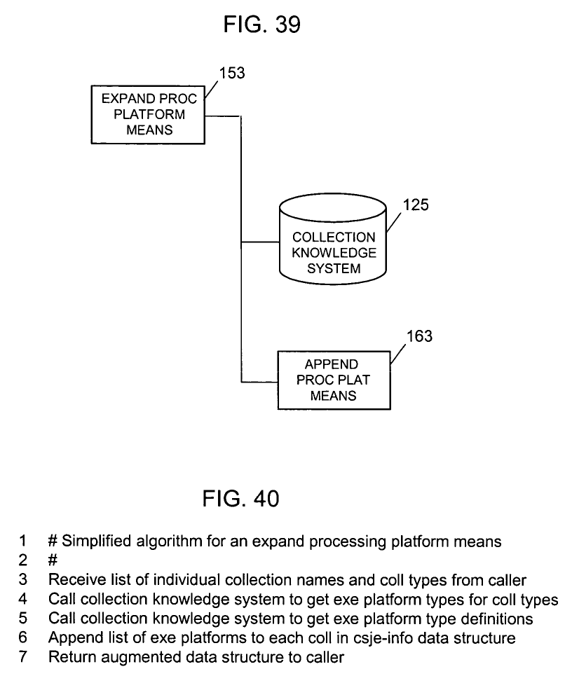

FIG. 39 shows a simplified architecture for a module Expand Processing Platform Means 153. Two other modules help to carry out the function of Expand Processing Platform Means 153.

Collection Knowledge System 125 manages the data tables necessary to determine a set of processing platforms from a collection type.

Module Append Processing Platform Means 163 is a utility module that appends expanded processing platform information to the expanded list of individual collection names, as shown in FIGS. 17-19. Processing platform values may also be appended to a data structure such as the one shown in FIG. 20

FIG. 40 shows a simplified algorithm for a module Expand Processing Platform Means 153.

In operation, Expand Processing Platform Means 153 proceeds by performing a set of data table lookups similar to the ones that were performed to carry out visit order expansion. The main difference is that platform expansion uses a different set of tables that involve collection types, processing platform types, processing platform type definitions, and processing platforms instead of visit order values.

First, Expand Processing Platform Means 153 receives a list of individual collection names and corresponding collection types. Suppose one of the collection types was “ct-program-c,” as we used in the previous example concerning visit orders.

Next, using data tables from a Collection Knowledge System 125 or equivalent, Expand Processing Platform Means 153 looks up a collection type “ct-program-c” in a collection type name table FIG. 31 Line 4 to obtain a collection type definition file “ct-program-c.def” as shown in FIG. 32.

Next, module Expand Processing Platform Means 153 looks in the collection type definition file FIG. 32 Line 5 to obtain a processing platform type “pp-program-c.”

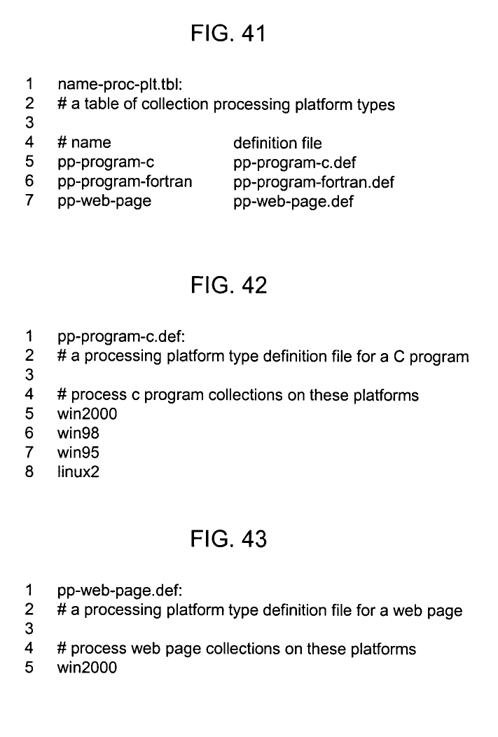

FIG. 41 shows a processing platform name table from a collection knowledge system. The table contains processing platform type names and corresponding processing platform type definition filenames.

Next, module Expand Processing Platform Means 153 looks up the processing platform type name “pp-program-c” in FIG. 41 Line 5 Column 1, to obtain the name of a processing platform type definition file “pp-program-c.def” from Line 5 Column 2.

FIG. 42 shows an example processing platform type definition file for a processing platform type of “pp-program-c.” Lines 5-8 of this file specify that all collections of processing platform type “pp-program-c” should be processed on four user-defined (not trademarked) platform names (win2000, win98, win95, and linux2).

FIG. 43 shows an example processing platform type definition file for a processing platform type of “pp-web-page.” Line 5 of this file specifies that all collections of processing platform type “pp-web-page” should only be processed on one platform, win2000.

Once module Expand Processing Platform Means 153 obtains a list of processing platforms for each collection name in the incoming list of expanded collection names, it calls Append Processing Platform Means 163 to append the new platform data to the list of collection names. The new processing platform information allows job triplets containing platform information to be constructed, as shown in FIGS. 17-19.

Append Processing Platform Means 163 may append new platform information to a comprehensive data structure such as shown in FIG. 20. Those skilled in the programming arts will recognize that one possible and efficient way to conveniently aggregate expansion information as it is determined, is to pass the data structure of FIG. 20 around among key modules described in this document.

This concludes our explanation of detailed symbolic job expansion actions.

### Summary of Expansion Descriptions

The foregoing sections have described collections, collection storage systems that manage collection namespaces, collection namespace references, collection shortcut references, symbolic job requests, collection reference expansions, default and explicit visit order expansions, and processing platform expansions.

Furthermore, extensive figures and tables have been provided to show the inventive architectures, data structures, and algorithms that characterize a preferred implementation of a Collection Symbolic Job Expander.

### CONCLUSION

The present Collection Symbolic Job Expander invention has several practical applications in the technological arts. It enables people and programs to use convenient, symbolic job request expressions to perform complex operations on large numbers of collections with essentially no human effort involved. It frees people from having to remember precisely which collections are members of a set of collections that can be referenced by a convenient shortcut expression. It frees people from having to remember tedious processing details such as visit orders and processing platform assignments for individual collections.

It provides practical solutions to several important problems faced by people who use collection processing systems to work with groups of related collections. The problems are: (1) the Collection Symbolic Job Expansion Problem, (2) the Collection Reference Expansion Problem, (3) the Collection Visit Ordering Problem, and (4) the Collection Platform Assignment Problem.

The present Collection Symbolic Job Expander invention enables people and programs to perform advanced collection processing on large sets of collections, using inventive structures that were not previously known to the art.

### RAMIFICATIONS

Although the foregoing descriptions are specific, they should be considered as example embodiments of the invention, and not as limitations of the invention. Many other possible ramifications can be imagined within the teachings of the disclosures made here.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be spread across a different set of coherent data structures, or could be split into a plurality of smaller data structures for implementation convenience, without loss of purpose or functionality.

As a second example, particular software architectures have been presented here to strongly associate primary algorithmic functions with primary modules in the software architectures. However, because software is so flexible, many different associations of algorithmic functionality and module architectures are also possible, without loss of purpose or technical capability. At the under-modularized extreme, all algorithmic functionality could be contained in one big software module. At the over-modularized extreme, each tiny algorithmic function could be contained in a separate little software module. Program modules could be contained in one executable, or could be implemented in a distributed fashion using client-server architectures and N-tier application architectures, perhaps involving application servers and servlets of various kinds.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented in this disclosure comprise one such implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to software inventions than are flexible architectures, simplified algorithms, or particular organizations of data structures.

Means For Storing and Retrieving Information

The foregoing disclosure used simple text files to illustrate various structured tables of information, but other implementations are also possible. For example, all software means for retrieving information from the simple text files shown here might also be implemented to retrieve information from a relational database, or from files contained in hidden directories within collections, or from other data providing means such as client-server systems for managing collection type definitions and associated files. Those skilled in the programming arts will understand that there are many generally equivalent ways of storing and retrieving information for the purposes of the present invention.

Other Means for Expanding Collection References

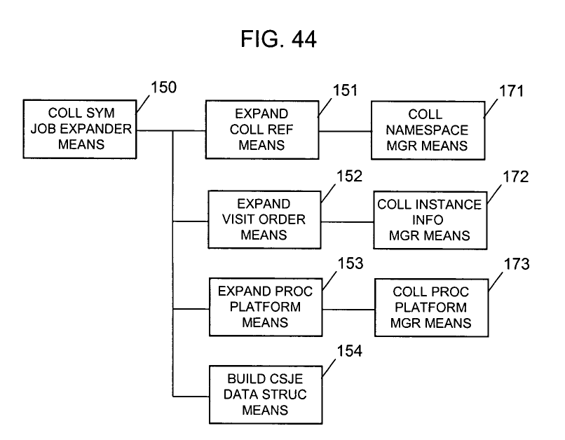

The foregoing disclosure described a preferred implementation of a Collection Symbolic Job Expander means, but other means are also possible, and generally equivalent in both structure and function. This equivalence can be understood by considering the software architecture shown in FIG. 44.

FIG. 44 shows a simplified architecture for a Collection Symbolic Job Expander Means 150 that uses three modules 171-173 that manage particular types of information that are required to perform symbolic job expansion actions.

Module Collection Namespace Manager Means 171 manages a collection namespace and interprets collection references within the namespace.

One of the main functions of Collection Namespace Manager Means 171 is to expand shortcut collection references such as shown in FIG. 10 into expanded lists of individual collection names such as shown in FIG. 13.

Those skilled in the programming arts will recognize that there are many ways known to the prior art of implementing a Collection Namespace Manager Means 171. For example, a simple text file of collection pathnames that mimicked actual filesystem locations of actual collections FIG. 5 contains enough information to support collection reference expansion actions. Other, more complex implementations that use structured text files or relational databases are also possible. A full-blown Collection Storage System 124 is not required to perform shortcut collection reference expansions.

However, these simpler implementations have some practical limitations. For example, a Collection Storage System 124 dynamically expands shortcut references by examining the actual contents of the storage systems. New collections that have been added by other people will immediately show up in the next shortcut expansion performed by the system. This means that up-to-date shortcut expansions are a by-product of normal configuration management activities such as adding, deleting, and renaming collections in the storage system.

In contrast, people must explicitly update the text files or databases that implement a simple collection namespace manager system, whenever collection names are added, removed, or renamed within the namespace. In other words, people working in a normal programming environment would have to manually coordinate changes to a collection storage system and changes to a Collection Namespace Manager Means 171. This is a practical limitation on the utility of simple namespace manager and expansion systems, because they can increase (not decrease) the work required of people who use the system.

Those skilled in the programming arts will also recognize that module Expand Collection Reference Means 151 needs only a suitable software interface API (application programming interface) in order to carry out its function. The implementation on the other side of the API interface is not material to either module Expand Collection Reference Means 151 or to the inventive means and structures of the present invention.

It follows that even though this disclosure used a Collection Knowledge System 125 to aid module Expand Collection Reference Means 151, other equivalent implementations such module Collection Namespace Manager Means 171 are also possible, and are generally equivalent in function and results for the purposes of the present invention.

Other Means For Determining Visit Orderings

FIG. 44 shows a simplified architecture for a Collection Symbolic Job Expander Means 150 that uses three modules 171-173 that manage particular types of information that are required to perform symbolic job expansion actions.

Module Collection Instance Information Manager Means 172 manages a database of collection instance information, including information contained in a collection specifier file such as explicit collection visit order values. In addition, this module manages a database of collection types and default visit orders, perhaps implemented using tables similar to those shown in FIGS. 31-35.

One of the main functions of a Collection Instance Information Manager Means 172 is to support the information requirements of an Expand Visit Order Means 152, so that proper visit order rankings can be calculated for collections on an expanded list of individual collections.

Those skilled in the programming arts will recognize that there are many ways known to the prior art of implementing a Collection Instance Information Manager Means 172. For example, the simple text files from a Collection Knowledge System 125 shown in FIGS. 31-35 could be used as one possible implementation. A full-blown Collection Storage System 125 is not required to support the calculation of proper visit order rankings.

Those skilled in the programming arts will also recognize that module Expand Visit Order Means 152 needs only a suitable software interface API (application programming interface) in order to carry out its function. The implementation on the other side of the interface is not material to either module Expand Visit Order Means 152 or to the inventive means and structures of the present invention.

It follows that even though this disclosure used a Collection Knowledge System 125 to aid module Expand Visit Order Means 152, other equivalent implementations such as module Collection Instance Information Manager Means 172 are also possible, and are generally equivalent in function and results for the purposes of the present invention.

Other Means for Determining Platform Assignments

FIG. 44 shows a simplified architecture for a Collection Symbolic Job Expander Means 150 that uses three modules 171-173 that manage particular types of information that are required to perform symbolic job expansion actions.

Module Collection Processing Platform Manager Means 173 manages a database of processing platform information, including information such as processing platform types FIG. 41 and processing platform type definition files FIG. 42-43.

One of the main functions of a Collection Processing Platform Manager Means 173 is to support the information requirements of an Expand Processing Platform Means 153, so that proper processing platform expansions can be performed on an expanded list of individual collections.

Those skilled in the programming arts will recognize that there are many ways known to the prior art of implementing a Collection Processing Platform Manager Means 173. For example, the simple text files from a Collection Knowledge System 125 shown in FIGS. 41-43 could be used as one possible implementation. A full-blown Collection Knowledge System 125 is not required to support processing platform expansions.

Those skilled in the programming arts will also recognize that module Expand Processing Platform Means 153 needs only a suitable software interface API (application programming interface) in order to carry out its function. The implementation on the other side of the interface is not material to either module Expand Processing Platform Means 153 or to the inventive means and structures of the present invention.

It follows that even though this disclosure used a Collection Knowledge System 125 to aid module Expand Processing Platform Means 153, other equivalent implementations such as module Collection Processing Platform Manager Means 173 are also possible, and are generally equivalent in function and results for the purposes of the present invention.

Other implementation approaches are also possible within the teachings of the present invention, such as using flat text files, binary random access files, hidden files, hidden directories within a collection, or object-oriented databases instead.

Practical Applications

The present Collection Symbolic Job Expander has many practical applications in the technical arts. For example, application programs can use the present invention to expand shortcut collection references into detailed lists of individual collection names.

As a second practical application example, Collection Processing Systems can use a Collection Symbolic Job Expander to expand convenient, symbolic job requests into long lists of detailed job triplets that can be executed in a distributed, multiplatform, and parallel execution manner, thereby greatly increasing the productivity of people who work with collections.

### SCOPE

The full scope of the present invention should be determined by the accompanying claims and their legal equivalents, rather than from the examples given in the specification.

Readers are once again reminded to be careful not to confuse the intended meanings of special lexicographic terms such as “collection” in this application with the common dictionary meaning of such words.

Readers should be aware that much novel and inventive structure is introduced into the claims below by including special terms and inventive data structures such as “collection symbolic job request” and “collection reference expression” and “collection job expansion action” in claim clauses, where the special terms serve to narrow and limit the claims.

1. A Collection Symbolic Job Expander process for expanding a collection symbolic job request into a list of expanded job requests, to be performed on or with the aid of a computer, comprising the following steps:
(a) receiving a collection symbolic job request from a request originator to perform a collection job expansion action on said collection symbolic job request,
(b) performing said collection job expansion action on said collection symbolic job request using a collection symbolic job expander means to produce an expanded job list,
(c) returning said expanded job list to said request originator,
wherein said collection symbolic job request is comprised of a symbolic task name and a collection reference expression, and wherein said expanded job list is comprised of a list of expanded job requests, each comprised of said symbolic task name, an expanded collection name, a computing platform name, and a collection visit order value,
thereby solving the Collection Symbolic Job Expansion Problem, and improving the productivity of people who process collections by enabling them to use a convenient symbolic job syntax for requesting complex processing tasks on large sets of collections.

2. The process of claim 1, wherein
(a) said step of performing said collection job expansion action uses information from a collection storage system to expand a collection reference expression,
thereby solving the Collection Reference Expansion Problem, and thereby improving human productivity by enabling people to use convenient collection reference expressions to refer to sets of collections, without being responsible for knowing exactly which collections are members of said sets of collections.

3. The process of claim 1, wherein
(a) said step of performing said collection job expansion action uses information from a collection type definition to determine platform assignment information, and
wherein said collection type definition is a user-defined set of attributes that are useful to application programs for understanding and processing collections,
thereby solving the Collection Platform Assignment Problem, and thereby improving human productivity by enabling collection processing programs to automatically determine platform assignment details for collection job requests in ways that were not previously known to the art.

4. The process of claim 1, wherein
(a) said step of performing said collection job expansion action uses information from a collection specifier or from a collection type definition to determine collection visit order values, and
wherein collection specifiers contain information about collection instances, including collection type indicators and explicit visit order values, and wherein said collection type definition is a user-defined set of attributes that are useful to application programs for understanding and processing collections,
thereby solving the Collection Visit Order Problem, and thereby improving human productivity by enabling collection processing programs to automatically determine collection visit order values to enforce processing dependencies among collections in a set, in ways that were not previously known to the art.

5. A programmable Collection Symbolic Job Expander device for expanding a collection symbolic job request into a list of expanded job requests, whose actions are directed by software executing a process comprising the following steps:
(a), receiving a collection symbolic job request from a request originator to perform a collection job expansion action on said collection symbolic job request,
(b) performing said collection job expansion action on said collection symbolic job request using a collection symbolic job expander means to produce an expanded job list,
(c) returning said expanded job list to said request originator,
wherein said collection symbolic job request is comprised of a symbolic task name and a collection reference expression, and wherein said expanded job list is comprised of a list of expanded job requests, each comprised of said symbolic task name, an expanded collection name, a computing platform name, and a collection visit order value,
thereby solving the Collection Symbolic Job Expansion Problem, and improving the productivity of people who process collections by enabling them to use a convenient symbolic job syntax for requesting complex processing tasks on large sets of collections.

6. The programmable device of claim 5, wherein
(a) said step of performing said collection job expansion action uses information from a collection storage system to expand a collection reference expression,
thereby solving the Collection Reference Expansion Problem, and thereby improving human productivity by enabling people to use convenient collection reference expressions to refer to sets of collections, without being responsible for knowing exactly which collections are members of said sets of collections.

7. The programmable device of claim 5, wherein
(a) said step of performing said collection job expansion action uses information from a collection type definition to determine platform assignment information, and
wherein said collection type definition is a user-defined set of attributes that are useful to application programs for understanding and processing collections,
thereby solving the Collection Platform Assignment Problem, and thereby improving human productivity by enabling collection processing programs to automatically determine platform assignment details for collection job requests in ways that were not previously known to the art.

8. The programmable device of claim 5, wherein
(a) said step of performing said collection job expansion action uses information from a collection specifier or from a collection type definition to determine collection visit order values, and
wherein collection specifiers contain information about collection instances, including collection type indicators and explicit visit order values, and wherein said collection type definition is a user-defined set of attributes that are useful to application programs for understanding and processing collections,
thereby solving the Collection Visit Order Problem, and thereby improving human productivity by enabling collection processing programs to automatically determine collection visit order values to enforce processing dependencies among collections in a set, in ways that were not previously known to the art.

9. A computer readable memory, encoded with data representing a Collection Symbolic Job Expander computer program, that can be used to direct a computer when used by the computer, comprising:
(a) means for receiving a collection symbolic job request from a request originator to perform a collection job expansion action on said collection symbolic job request,
(b) means for performing said collection job expansion action on said collection symbolic job request using a collection symbolic job expander means to produce an expanded job list,
(c) means for returning said expanded job list to said request originator,
wherein said collection symbolic job request is comprised of a symbolic task name and a collection reference expression, and wherein said expanded job list is comprised of a list of expanded job requests, each comprised of said symbolic task name, an expanded collection name, a computing platform name, and a collection visit order value,
thereby solving the Collection Symbolic Job Expansion Problem, and improving the productivity of people who process collections by enabling them to use a convenient symbolic job syntax for requesting complex processing tasks on large sets of collections.

10. The computer readable memory of claim 9, wherein
(a) said means for performing said collection job expansion action uses information from a collection storage system to expand a collection reference expression,
thereby solving the Collection Reference Expansion Problem, and thereby improving human productivity by enabling people to use convenient collection reference expressions to refer to sets of collections, without being responsible for knowing exactly which collections are members of said sets of collections.

11. The computer readable memory of claim 9, wherein
(a) said means for performing said collection job expansion action uses information from a collection type definition to determine platform assignment information, and
wherein said collection type definition is a user-defined set of attributes that are useful to application programs for understanding and processing collections,
thereby solving the Collection Platform Assignment Problem, and thereby improving human productivity by enabling collection processing programs to automatically determine platform assignment details for collection job requests in ways that were not previously known to the art.

12. The computer readable memory of claim 9, wherein
(a) said means for performing said collection job expansion action uses information from a collection specifier or from a collection type definition to determine collection visit order values, and
wherein collection specifiers contain information about collection instances, including collection type indicators and explicit visit order values, and wherein said collection type definition is a user-defined set of attributes that are useful to application programs for understanding and processing collections,
thereby solving the Collection Visit Order Problem, and thereby improving human productivity by enabling collection processing programs to automatically determine collection visit order values to enforce processing dependencies among collections in a set, in ways that were not previously known to the art.
